(19) United States
(12) Patent Application Publication
(10) Pub. No.: US 2015/0348161 A1
(43) Pub. Date: Dec. 3, 2015

(54) ELECTRONIC SAMPLE PALETTE SYSTEM AND FILTERS

(71) Applicants: Gerald Thomas Freeman, Highland Park, IL (US); Tamara Davis, Chicago, IL (US)

(72) Inventors: Gerald Thomas Freeman, Highland Park, IL (US); Tamara Davis, Chicago, IL (US)

(21) Appl. No.: 14/728,725

(22) Filed: Jun. 2, 2015

Related U.S. Application Data
(60) Provisional application No. 62/006,670, filed on Jun. 2, 2014.

(51) Int. Cl. G06Q 30/06; G06F 3/0484

(52) U.S. Cl. CPC G06Q 30/0627; G06F 3/04845; G06F 3/04847; G06F 3/04842; G06Q 30/0609

(57) ABSTRACT

The present embodiments provide systems for generating sample(s) requests, pricelists, technical data, and sample books orders over a network. In one embodiment, a database stores design products related to a plurality of categories of commercial products from a plurality of manufacturers. Interface circuitry displays the plurality of categories of commercial products along with filtering criteria that may be selected by a user. A sample palette server is in operative communication with the database and the interface circuitry and receives a user selection of one or more filtering criteria specifying one or more requested design features. The sample palette server generates a subset of the design products sharing at least one design feature in common with the requested design features. Filtering circuitry filters the displayed plurality of categories of commercial products to include only design products from the subset of design products and causes the interface circuitry to display a second set of filtering criteria for the displayed plurality of categories of commercial products. Sample palette generating circuitry receives a user selection of a plurality of commercial products from the displayed subset of design products and generates a sample palette including graphical images of the plurality of commercial products.

### CROSS-REFERENCE TO RELATED APPLICATIONS

The present application claims the priority benefit of U.S. Provisional Patent Application No. 62/006,670, filed Jun. 2, 2014, which is hereby incorporated by reference in its entirety.

### TECHNICAL FIELD

The present description relates to a system for a manufacturer's representative to order materials and track data related to interior and exterior design. In particular, the present description relates to a system for electronically generating sample palettes via a website or tablet app accessible by manufacturer representatives.

### BACKGROUND

In the interior design industry, manufacturer's representatives often have to provide samples and product information that include one or more combinations of different product samples (e.g., carpet, flooring, fabric, plastic, laminate, etc.) that will be used to decorate an interior or exterior space (e.g., office, apartment, building, etc.). These samples are presented to client and potential clients during a sales pitch and are a very important part of the interior design business.

Currently, these samples and product information are compiled by manually filling out forms and faxing each form to the respective manufacturer's customer service department, by emailing the information for the materials needed to the representative, or by calling customer service and relaying the information for the materials needed. In any scenario, the forms are individually submitted to respective manufacturers of the product and then physical product samples are collected and eventually presented to the client.

The current process is a very slow and labor-intensive process that takes many hours of the ‘representative's time. In addition, this process is further extended by the fact that multiple manufacturers’ representatives often must order separate product samples from different manufacturers. Therefore, there is a need for an improved system for ordering product samples and aggregating product sample information into sample palettes.

### SUMMARY

The electronic system described herein allows a manufacturer's representatives to quickly evaluate products with their clients and to order samples and technical data for a wide range of products quickly and efficiently. The system further allows manufacturer's representatives to create and manage their product samples and orders online, such as via web browsers. The system further allows manufacturer's representatives to submit and manage their products and also acts as a forum for all users (e.g., designers, manufacturers, students, etc.) to interact with other users and exchange opinions about different products.

In another aspect, the system further stores a sample history of all samples ordered and allows representatives and other users to sort the data in numerous ways, such as by client name, firm name, product style, product color, and so forth. The manufacturer's representative can also create electronic sample palettes featuring products that they sell along with coordinating products. Each electronic palette (or e-palette) created can be shared with other users (e.g., via email or social media), printed, or downloaded to a user's computer. The system also allows a user to work on multiple sample palettes at one time. Further, the system allows a manufacturer's representative to order multiple physical samples of all of the products in their palette(s) or download all of the specification sheets, warranty sheets, maintenance sheets, installation instructions and MSDS sheets at one time or create a project binder. Therefore, the system in accordance with the present descriptions provides technical solutions to the technical problems of the traditional process and saves the manufacturer's representatives hundreds of hours per year.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 depicts a schematic illustration of a system for generating electronic palettes according to embodiments of the invention.

FIG. 2 illustrates an electronic palette server and databases for use with the system for generating the electronic palette of FIG. 1.

FIG. 3 further illustrates an exemplary database of FIG. 2.

FIG. 4 depicts a method for generating an exemplary electronic palette according to embodiments of the invention.

FIGS. 5A-5B and 6AA-6GB illustrate webpages of an exemplary electronic palette website generated by the server of FIG. 2 according to some embodiments.

FIG. 7 depicts an electronic palette generated by the server of FIG. 2.

FIG. 8 is an order samples webpage of the exemplary electronic palette website generated by the server of FIG. 2.

FIG. 9 depicts exemplary operations that may be performed by a method for registering representatives with the system and generating sample palettes.

FIGS. 10A-12 illustrate exemplary interfaces of a website implementing various aspects of the electronic sample palette website generated by the server of FIG. 2 according to some embodiments.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The systems shown in the figures are models of what actual systems might be like. It should also be noted that a plurality of hardware and software based devices, as well as a plurality of different structural components, may be utilized to implement the invention. Although referred to herein as modules, it should further be noted that many of the modules and logical structures described are implemented using respective circuitry programmed to execute the particular tasks described herein, such as microprocessors and other circuitry components. Many of the modules, therefore, may be implemented utilizing a variety of components, including circuitry and other hardware. As described in subsequent paragraphs, the specific configurations illustrated in the drawings are intended to exemplify embodiments of the invention, and other alternative configurations are possible. Furthermore, throughout the specification capitalized terms are used. Such terms are used to conform to common practices and to help correlate the description with the coding examples, equations, and/or drawings. However, no specific meaning is implied or should be inferred simply due to the use of capitalization.

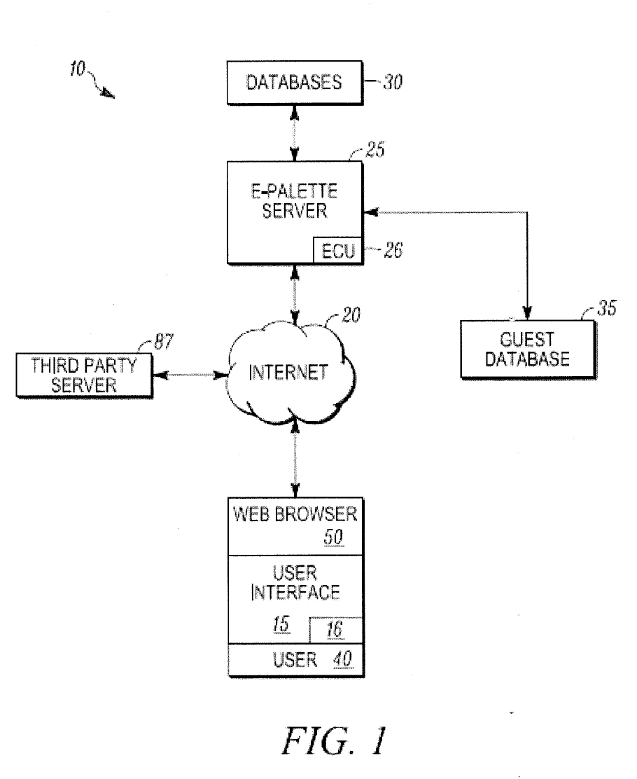

FIG. 1 depicts an electronic palette generation system 10 including a user interface 15, the Internet 20, and an e-palette server 25. The server 25 is coupled to databases 30 and, in some embodiments, to a guest database 35. The server 25 includes an Electronic Control Unit (ECU) 26 that controls the operation of the server 25 and the system 10. In some systems, the components of FIG. 1 are coupled via one or more networks, such as a local area network, wide area network, cellular network, and/or other types of networks, in addition to or in place of the Internet 20.

The user interface 15 can be a computer, a personal digital assistant (“PDA”), a tablet computer, a telephone, or any other device that allows a user 40 to connect to the server 25 via the Internet 20 or any other communication network. The user interface 15 includes a controller 16 (e.g., a processor of a computer) that communicates with the ECU 26 of the server 25 and with other user interfaces. Several types of users 40 can access the server 25. In some embodiments, the users 40 include a designer (that generally uses the system 10 to create a palette 45), a product manufacturer, manufacturer rep or vendor (that provides products to be included in the palette 45), and a system administrator (that supports the server 25 and the system 10). As explained in further details below, a designer user can include an interior designer, an architect, a student, or any other type of designer user.

At a high-level, one method of operation of the system 10 includes a product manufacturer at a user interface 15 inputting information about product sold by that manufacturer (i.e., various products to be included in a palette) to the server 25 via a web browser 50 and the Internet 20. A designer user uses a different user interface 15 to connect to the server 25 via a web browser 50, to access at least one of the databases 30, to search for and sort various products offered by different manufacturers, and to create an e-palette 45 that includes the provided palette information (e.g., various design products). A designer user can save the created palette 45 (see FIG. 7), can request a sample of all products for one or more palettes 45, and can download a specification sheet for every product included in the e-palette 45 or create a project binder 190 that could include the following documents: cover page 191, index 192, product page 193, specification sheet 194, installation sheet 195, maintenance sheet 196, warranty sheet 197, material safety data sheet 98 for all products included in the e-palette. In addition, the created e-palette 45 can be sent to the user computer 15 (e.g., via email or social media) or downloaded to the user computer 15 and locally saved on the computer).

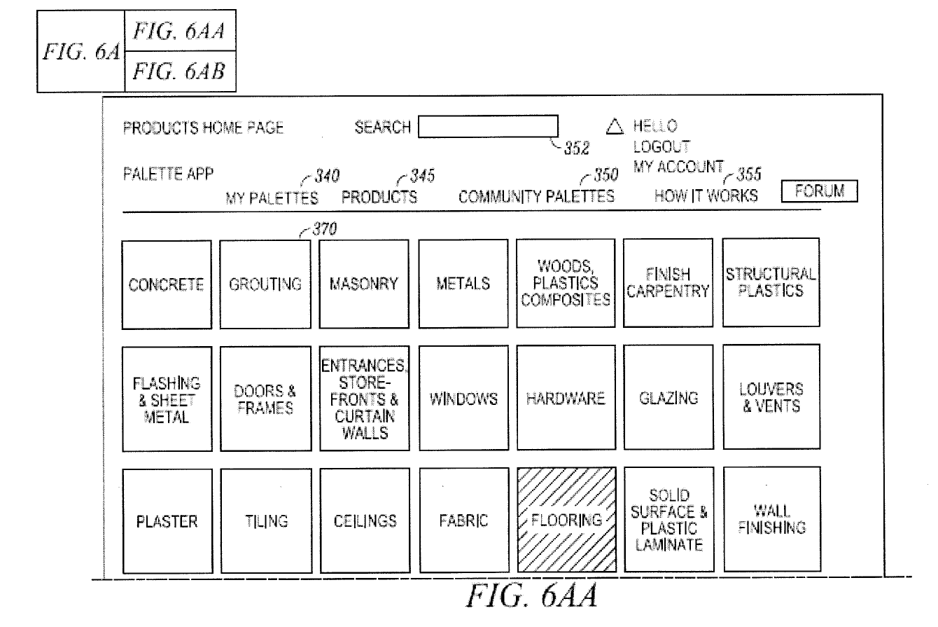

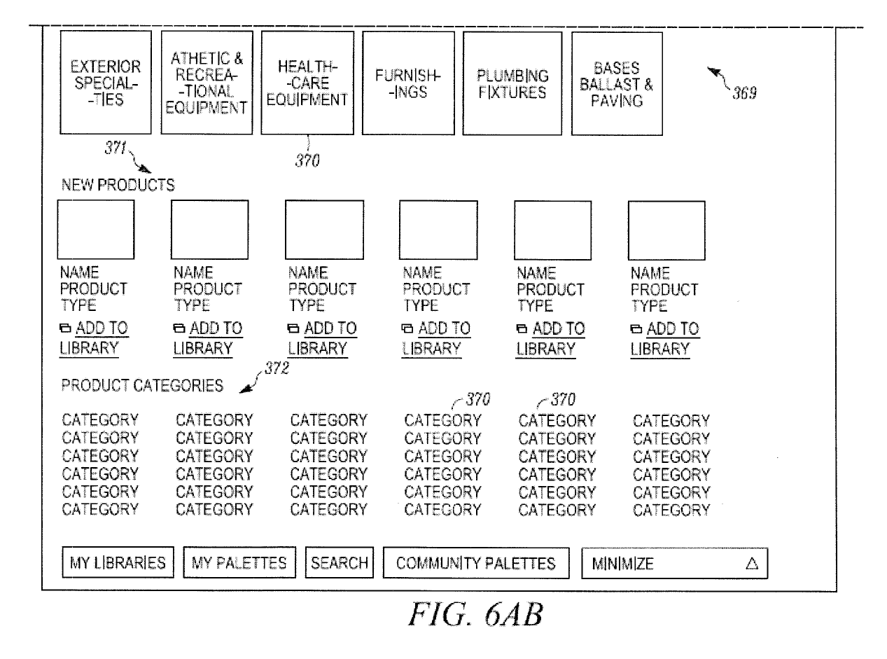

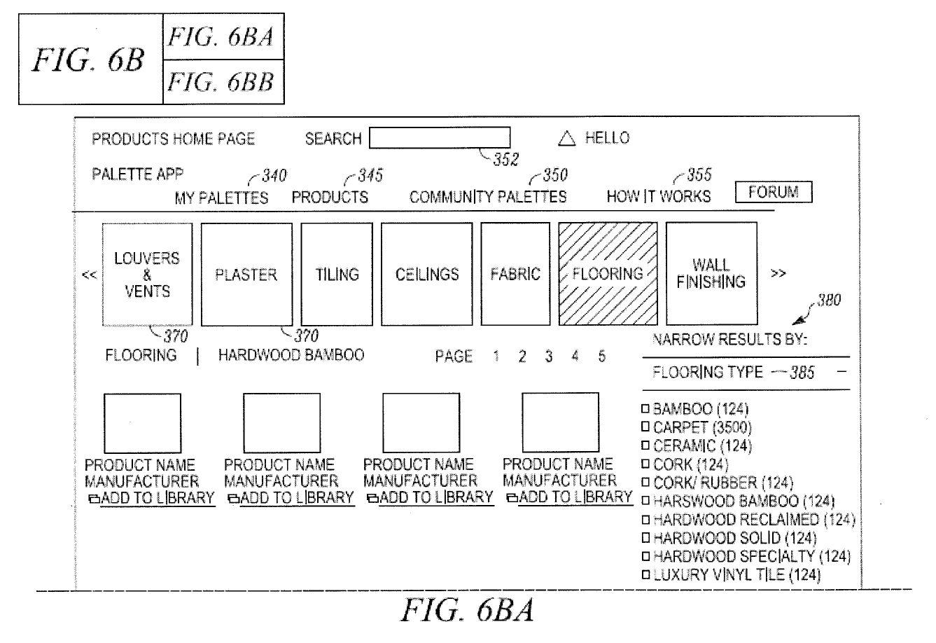

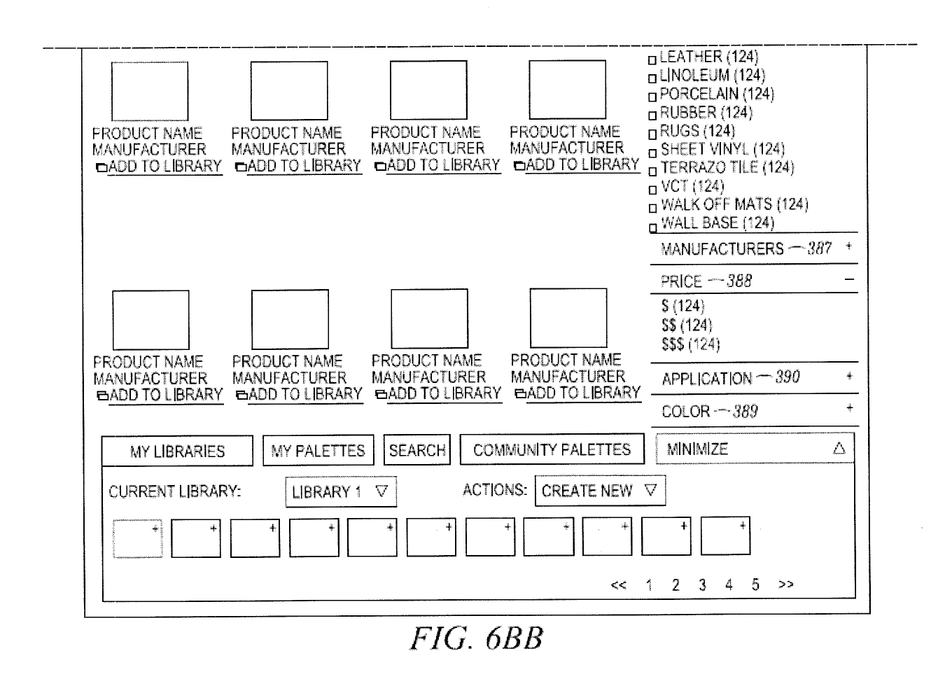

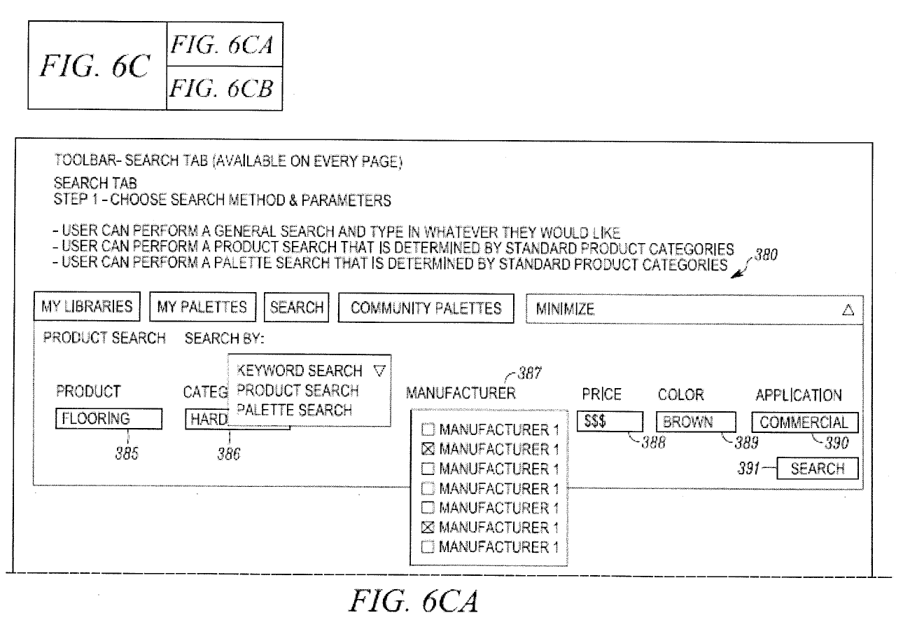

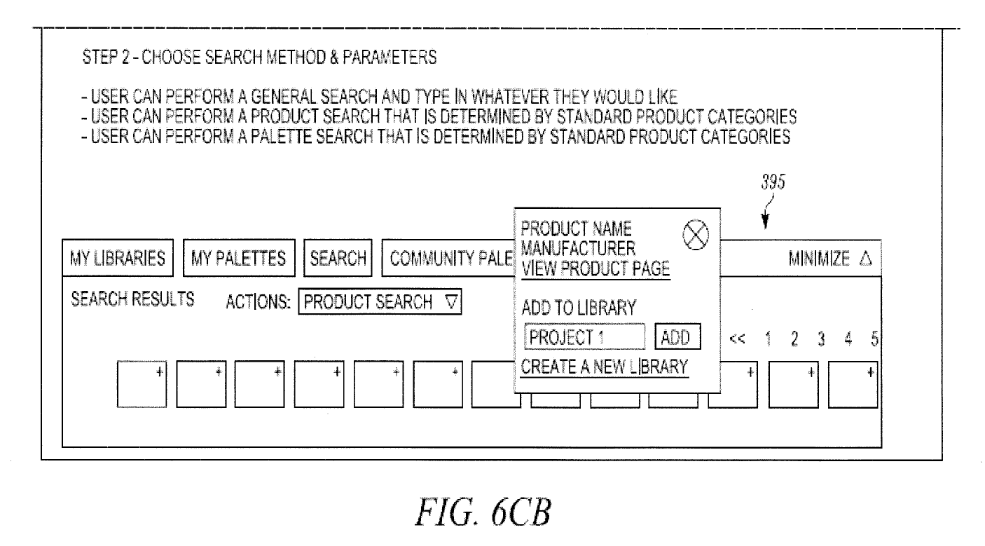

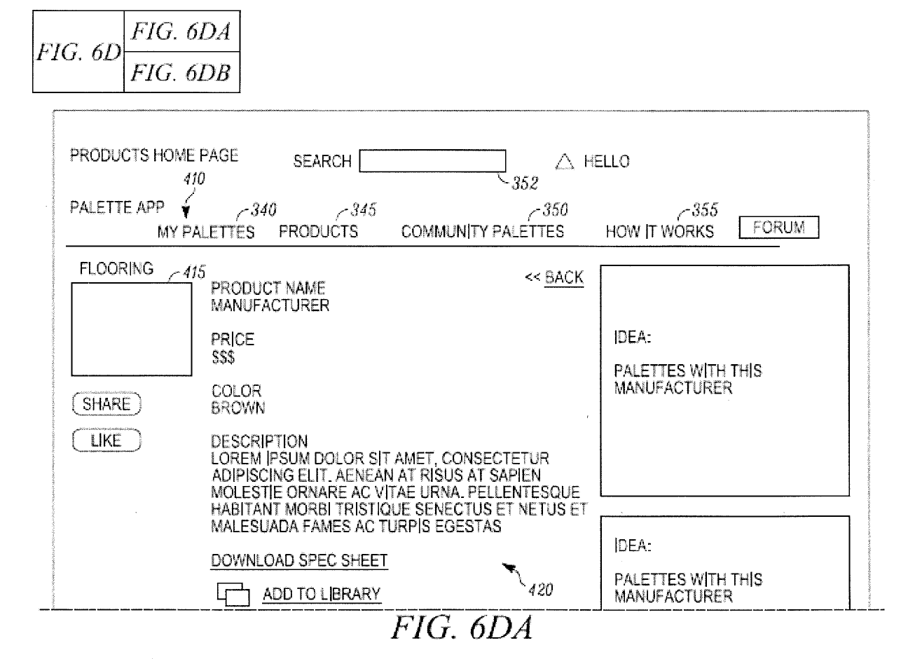

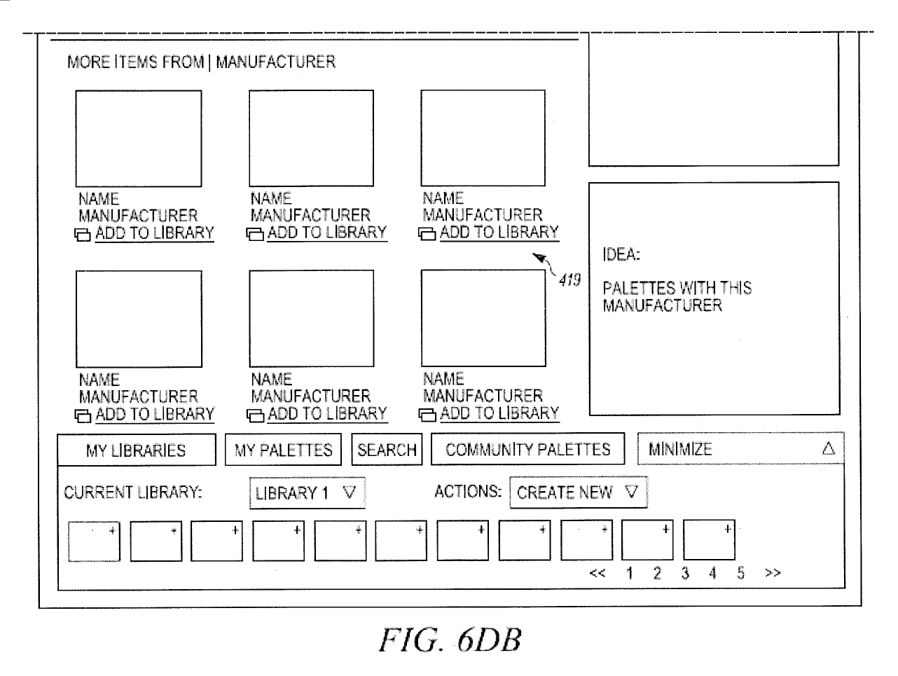

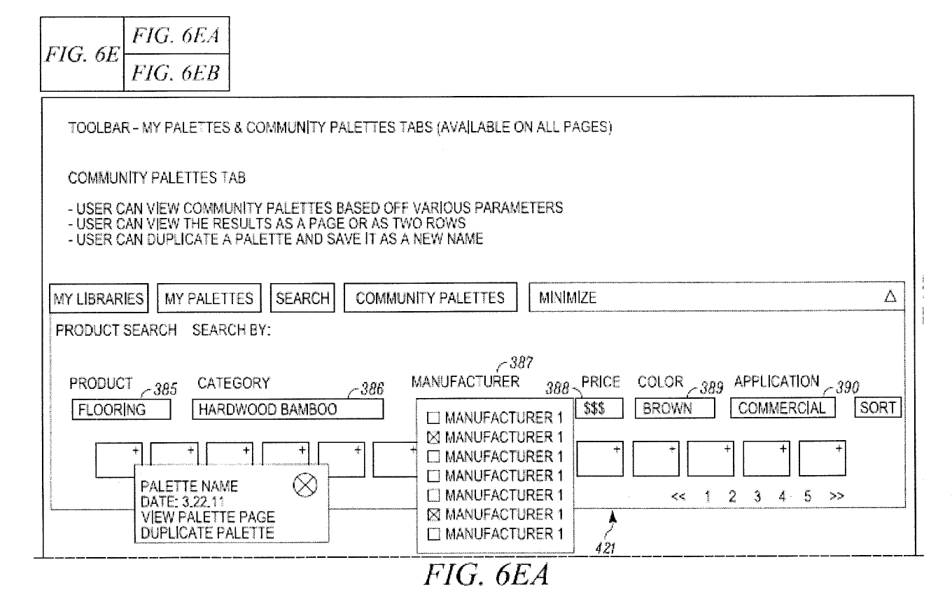

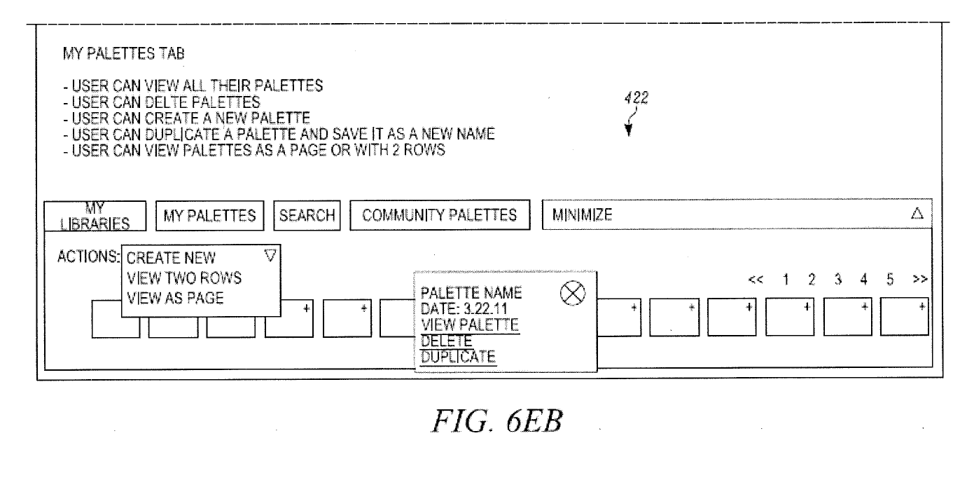

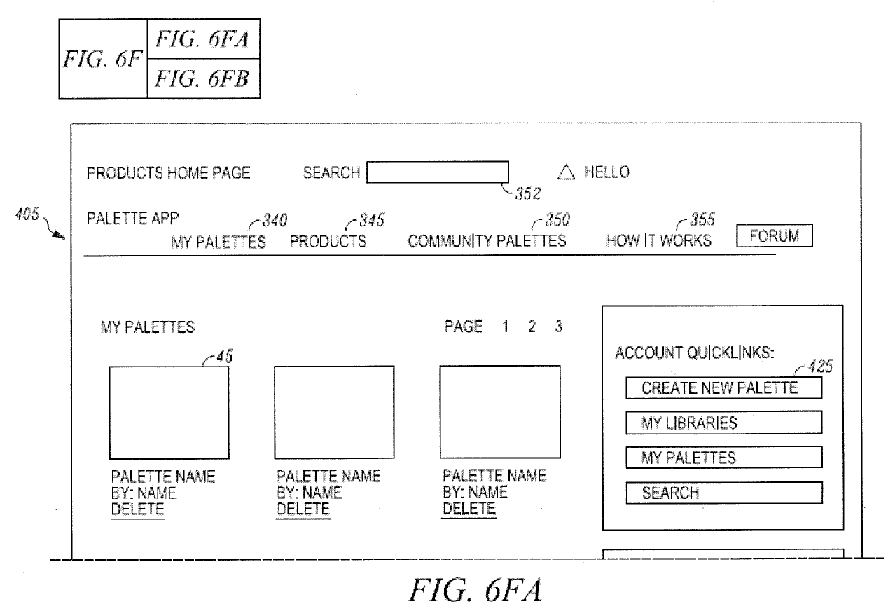

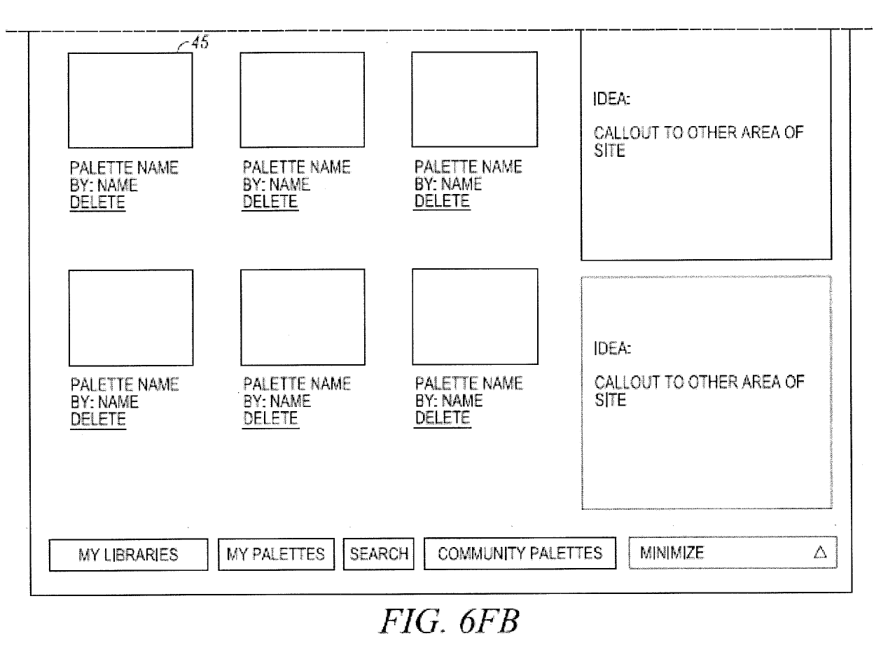

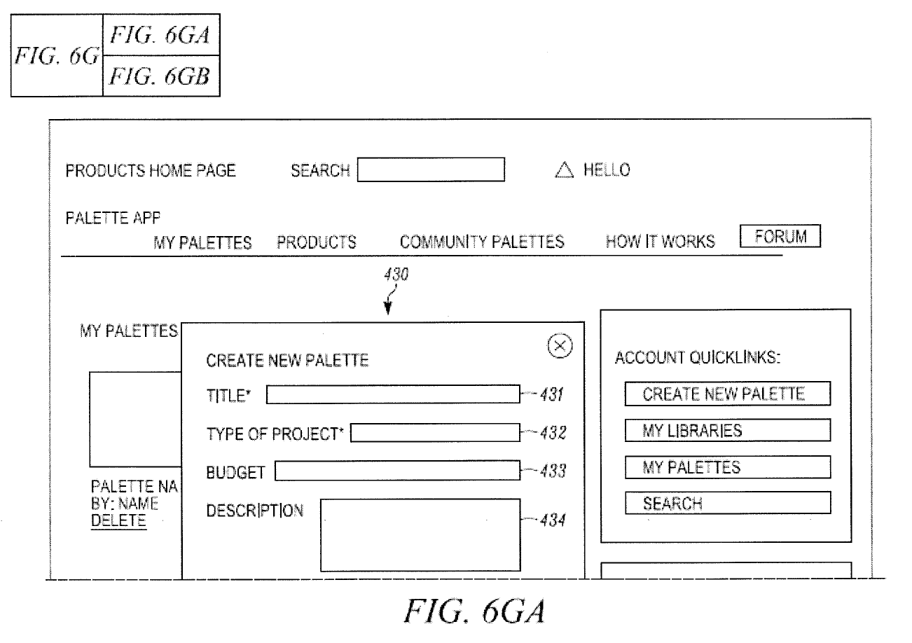

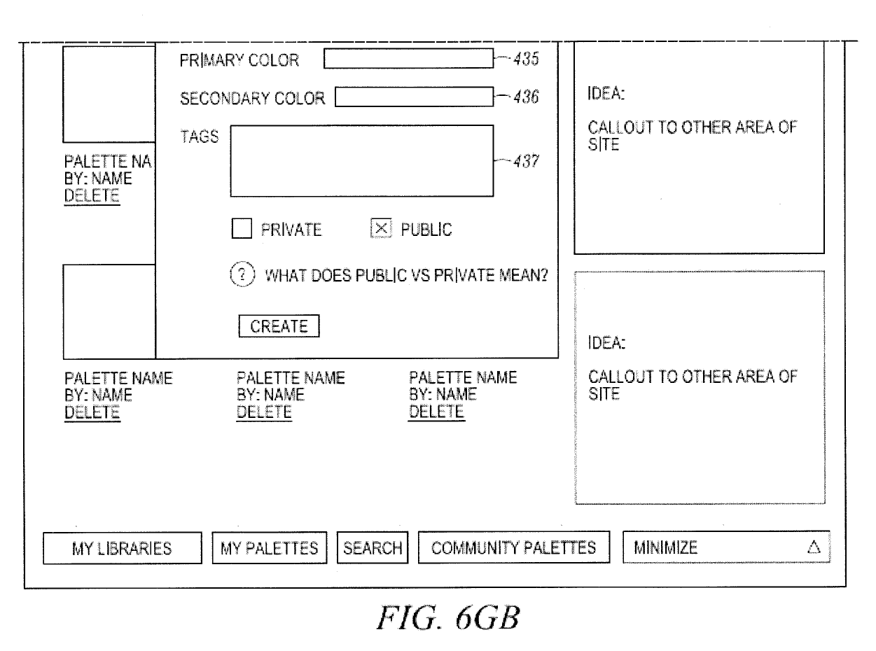

Similarly, a representative uses a different user interface 15 to connect to the server 25 via the server 25 via a web browser 50, to access at least one of the databases 30, create and generate sample palettes that are used by the representative to show a customer product options from one or more companies using a modified interface having features similar those show for e-palette 45. In addition to those features shown for e-palette 45, a representative (either of a single manufacture or an independent representative of multiple manufacturers) can use interface 15 to download their client base into the system databases 30 for later access. The representative can select products from one or more companies that they represent and drag and drop them into the sample box using an interface similar to that shown in FIGS. 6BA-6BB. Once all materials are selected, the representative can submit an order for the samples and select whether a sample, brochure, cut sheet, sample book, price list, and so forth, will be sent to the customer. The representative may then be prompted to input as much detail about the project as possible (i.e., project name, city, state, country, budget, general contractor, sub-contractor, owners representative, etc.) Once the representative submits the order, each manufacturer will be sent the data so that the particular sample or samples manufactured by that manufacturer (along with any brochures, cut sheets, sample books price lists, etc.) can be sent to the client. The project data is then downloaded into database 30 that allows the representative, or their superior, to view and organize the data into any combination of viewing options.

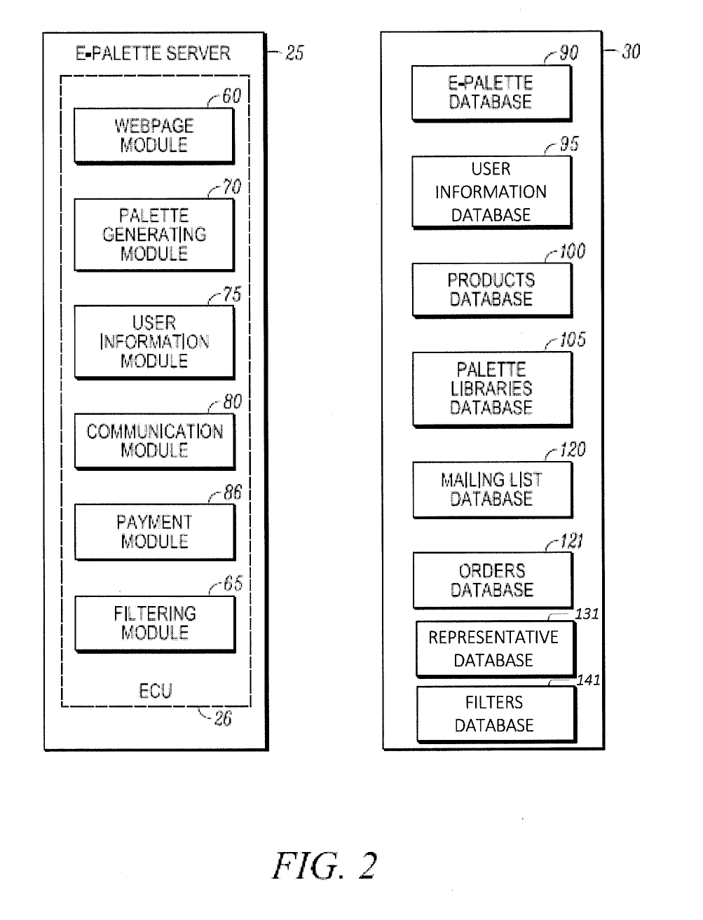

FIG. 2 depicts the server 25 and databases 30 in more detail. The ECU 26 of the server 25 includes various modules 56, which in some embodiments may be circuitry programmed to execute the particular tasks described, that control the operation of the server 25 and the system 10. The ECU 26 is a microcontroller that includes (or is connected to) memory (not shown) such as RAM and ROM and executes software that can be stored in the RAM (particularly during execution), the ROM (on a generally permanent basis), or another non-transitory computer readable medium, such as other memory or a disc. If necessary, the microcontroller can be connected to such memory or a disc drive to read such software. The ECU 26 may be implemented as a microprocessor or other programmable device (e.g., a field programmable gate array (FPGA), an application specific integrated circuit (ASIC), or the like) with suitable memory and I/O devices. The modules or circuitry 56 are created in any suitable software development language and on any type of platform by using the system's proprietary application program interface. Examples of suitable software languages include, but are not limited to, Visual Basic, Java, Adobe Flex, Adobe Flash, and HTML (please specify language if not included). Examples of platforms include, but are not limited to, WINDOWS®, UNIX®, LINUX®, and GOOGLE®.

In one embodiment, the server 25 includes a webpage module 60 and related webpage circuitry, filtering module 65 and related filtering circuitry, palette generating module 70 and related palette generating circuitry, user information module 75 and related user information circuitry, communication module 80 and related communication circuitry, and payment module 86 and related payment circuitry. In some embodiments, one or more of the modules or a portion thereof are located on a third party server 87. In other embodiments, the server 25 can include more or less modules or circuitry components.

The webpage module 60 and related webpage generates webpage data for output to the web browser 50. For instance, the web browser 50 receives webpage data generated by webpage module 60 and related webpage circuitry and displays the webpage data on a user interface 15. In some implementations, a portion of the webpage data is stored locally at user interface 15 from previous webpage data transfers and, therefore, an updated portion of webpage data is sent from server 25 to complement or overwrite the webpage data already stored on the user interface 15. Generally, at least a portion of the webpage data is generated “on-the-fly” after a user request. For instance, the webpage data may be customized to a particular user and/or date before being output to the web browser 50.

The filtering module 65 and related filtering circuitry filters the different products included in the databases 30 based on a specific user input. In some systems, the user inputs specific filtering characteristics (e.g., job size (square feet), type of use (commercial/residential), budget, primary color, carpet backing, etc.) into a filter in order to generate results directed towards a specific project. The filtering module 65 and related filtering circuitry filters the data stored into the databases 30 based on the directed input and displays products that fall within or satisfy the selected criteria. From the filtered product results, the user selects specific products and the system generates one or more e-palettes 45 for a particular project. In some implementations system, filter module 65 may access a set of filters, which may be stored in one or more databases, such as filters database 141. In addition to allowing users to filter displayed products for based on characteristics, filter module 65 allows users and representatives to access a unique and complex filtering system for a vast variety of architectural material.

The user information module 75 collects, analyzes, verifies, and stores user information. For instance, user information module 75 is operable to store user login and password information, as well as account information, in the user information database 95. The user information module 75 also collects, analyzes, verifies, and stores user information for representatives in representative database 131. As used herein, “user” may include a user, a representative, or both and “user information” may include information for both users and representatives. The user information module 75 compares user-entered login and password information for users and representatives from the web browser 50 with the stored information to verify the identity of a user at user interface 15. The user information module 75 is also operable to store user-entered preferences and to analyze user selection information. Through analysis of multiple palettes created by a particular user, the user information module 75 identifies selection trends of the user to generate selection suggestions. For instance, if a user 40 orders a sample product from a specific manufacturer, the user information module 75 is operable to store the manufacturer name and/or the product characteristics thereof, and later cause the server 25 to suggest another product of the same manufacturer or similar to the previously ordered product. When the user is a manufacturer's representative, the representative can download their client list to the system and user information module 75 can store the client list to the representative database 131 for quick access by the representative at a later time.

The communication module 80 allows users to communicate with other users in the system 10. Users can send messages to other users and can also communicate with nonusers, for example, to send a referral to a nonuser to join the system 10. The communication module 80 further allows manufacturer users to upload their products on the products database 100 located on the server 25. In addition, the communication module 80 allows the system administrator to communicate with all other users (e.g., to confirm registration, send requested data, etc.). In another embodiment, users can interact directly with other users via communication module 80. For example, users can use the system as a forum, ask questions, share ideas, news or comments regarding content, products, or created e-palettes.

The payment module 86 is configured to process users' payments. For instance, the payment module 86 receives user payment information (e.g., credit card information) entered by the user via web browser 50. In some embodiments, users pay a monthly subscription to the owner of the e-palette generation system 10. In addition, some users (e.g., student users) can use the system 10 free of charge. Similarly, payment module 86 receives payment from representatives. In some embodiments, representatives may pay a periodic charge (e.g., monthly or yearly), or representatives may pay a transaction fee associated with a particular event, such as for each submission of a sample palette or for the total the number of orders submitted as a part of a sample palette submission. In some implementations, a manufacturer may pay subscription fees for all their representatives associated with the manufacturer. The payment module 86 interacts with the third party server 87 (e.g., a credit card company server) to complete the transaction. For example, the payment module 86 is configured to operate in connection with an existing payment processing system (e.g., PAYPAL®, GOOGLE CHECKOUT®, etc.) that processes payments from a user. Thereafter, a confirmation is sent to the web browser 50 to indicate to the user that the transaction completed. In addition, the payment module 86 is configured to automatically process the user's monthly subscription to the system 10.

The databases 30 include the e-palette database 90, user information database 95, a products database 100, palette libraries database 105, mailing list database 120, orders database 121, representative database 131, and filters database 141. The databases 30 are coupled to the server 25 via a data link. In some systems the data link is a direct wired or wireless coupling. In other embodiments, the data link is a local network connection, which can include wired and wireless connections. In still other systems, the server 25 is connected to the databases 30 using a non-local network, such as a wide area network, a cellular network, or the Internet 20 (an embodiment not depicted in FIG. 1). This embodiment may also include local network connections between the server 25 and databases 30. Each of the databases within databases 30 includes an addressable memory, such as a hard disc or other medium able to store and retrieve digital information. In some embodiments, all or a portion of the databases within databases 30 are stored in a single memory device. The databases 30 also include software for storing received data, searching stored data, receiving data requests, retrieving the requested data, and outputting the data to the requester or other appropriate recipient.

In some embodiments, some or all of the databases 30 are integrated with the server 25. In other embodiments, individual databases within databases 30 are divided into multiple sub-databases that may be located in different locations and coupled together or to the server 25 using various networks and devices. In some implementations, the server 25 is one or more of an Xserve server offered by Apple, a PowerEdge server offered by Dell, a System x or BladeCenter server offered by IBM, Blade server offered by Oracle, or the like. In some implementations, the databases 30 are maintained by database software such as Microsoft SQL Server, Oracle Database, IBM DB2, or the like.

The e-palette database 90 includes e-palette templates that are used to form e-palettes by the e-palette generating module 70. The e-palette templates may include multiple choices for each customizable element and multiple combinations of elements. For example, one e-palette template includes the following elements/products: 2-3 carpet options (main carpet, office carpet and conference room carpet); 2-3 paint options (wall color, trim color and ceiling color); 2 plastic laminate samples for pantry/coffee/copy cabinets; 1-2 wood samples (flooring, wall panels, furniture); 1 glass sample; 1 latch-set for door hardware; 4-6 fabrics (furniture, walls, panels); 1 ceramic (bathroom or kitchen tiles); 1-2 vct samples (pantry/coffee/copy); 1 rubber sample; 1 marble or granite sample for lobbies; and 1-2 wall-covering samples. The e-palette template can include more or less elements/products. In other implementations, users are able to create their own e-palette templates and, via server 25, store the templates in the e-palette database 90.

The products database 100 includes products from various manufacturers that are used to create an e-palette 45. Manufacturer users store their own products information within the products database 100. For instance, a user is able to create a new product entry on the system for every new product that is to be presented on the system 10. The user specifies the type of product (e.g., carpet, paint, etc.), captures or creates a media (e.g., photo of a product, specification sheet, etc.) using user equipment (e.g., a computer, camera, sophisticated software, etc.), then uploads the product information including the media to the products database 100. All new products are included in a “New Products” section and need to be approved by a system administrator before they are accessible to other users.

The palette libraries database 105 includes e-palettes 45 that are created and saved by existing users 40. As explained in more detail below, after a user is registered, the user 40 can create and save one or more palettes 45 on the system 10. The user 40 can access these saved palettes at any time and delete them if he or she wishes to do so. In some embodiments, the palette libraries database 105 is indexable using a date. For instance, after a e-palette 45 is created, the e-palette 45 is saved on the palette libraries database 105 and is associated with a save and/or modified date. A user 40 can later access the system 10 and can view and sort his exiting palettes by the date characteristics associated with the palettes.

In some embodiments, e-palette database 90, products database 100, and palette libraries database 105 also store usage data related to other databases such as the quantity and/or frequency of previews of a product or e-palette template. This usage data is stored in a separate usage database (not shown), or within each respective database, or a combination thereof. Additionally, in some embodiments, the e-palette database 90, products database 100, and palette libraries database 105 store text such as tag or description data. The tag or description data provides additional text data for use in searching the databases.

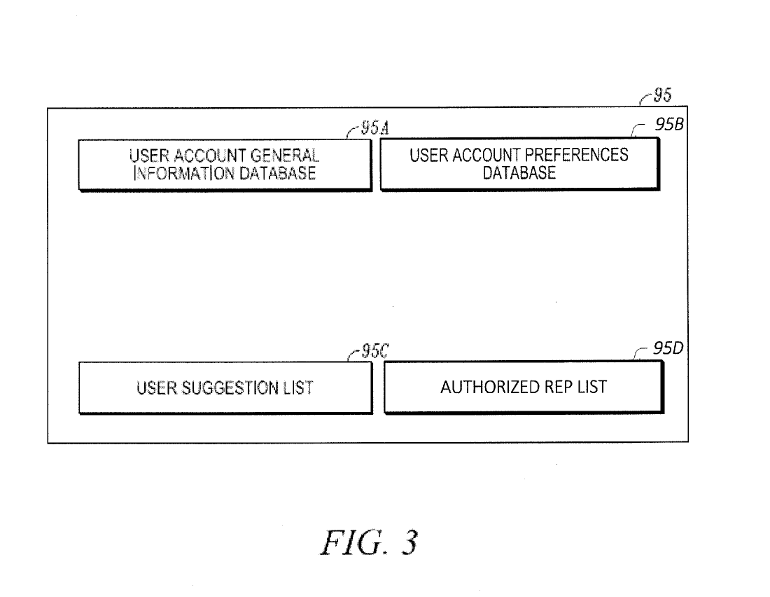

As shown in FIG. 3, the user information database 95 includes four sub-databases: user account general information database 95A, user account preferences database 95B, user suggestion list 95C, and authorized representative list 95D. Although the databases 95A-D are depicted as separate, in some embodiments, one or more of the sub-databases 95A-D are combined into a single database. In other embodiments, databases 95A-C are divided into more databases.

User account general information database 95A includes a user (or representative) name, user login, user password, user payment information (e.g., credit card information), and user account type information (e.g., designer, manufacturer, representative, authorized representative, etc.). The server 25, and in particular, the user information module 75, verifies user login and password information using the user account general information database 95A. The user account general information database 95A further stores user address, email address, phone number, and/or fax number that every user is required to input when creating an account. The user account type information includes the information about the type of user 40: designer user (that includes commercial or residential architect or designer), manufacturer user, student user, representatives, (both independent representative and manufacturer specific or single company representatives), and any other type of user. Generally, a user 40 provides this information when registering for the first time with the system 10. A user 40 can update and/or change information by using the user interface 15 and that change will be saved in the user account general information database 95A.

The user account preferences database 95B stores information about the types of products in which the user is interested. In some embodiments, the user account preferences database 95B includes data from the libraries created by each user. In other embodiments of the invention, additional user preferences are stored. For example, the type of manufacturer is included. In some implementations, the user account preferences database 95B is populated by the user, via the user information module 75 based on past viewed and/or selected products, browsing records, or other methods, or a combination thereof.

The data stored within the user suggestions list 95C includes one or more of e-palettes, products, and manufacturers associated with previous user activity on the website or user information otherwise obtained. Some information stored within the user suggestions list 95C may overlap or closely relate with information stored in user account preferences database 95B. Based on a user's prior selection of a product including, e.g., beige carpet X by company ABC, carpets Y and Z also by company ABC would be added to the user suggestions list 95C for suggestion during future e-palette creation by the same user. Suggested e-palette templates and manufacturers are similarly added to the user suggestions list 95C based on their inclusion within or similarity to a user's earlier website browsing or e-palette.

The data stored within authorized representative list 95D includes data associating authorized representatives with one or more manufacturers and/or authorized representatives for a particular manufacturer. During registration and creation of user accounts, a user registering as a representative are given the ability to select multiple manufacturing companies that they represent. Independent representatives may utilize user information module 75 to add or remove manufacturers that they represent at any time. Authorized representative list 95D includes a list of registered representatives (both independent and manufacturer specific or single company representatives), as well as the manufacturers that they represent and may be updated at periodic intervals or in real-time. Authorized representative list 95D may also include data associating each manufacturer with an administrator or supervisor for the manufacturer. Manufacturer supervisors may access administrative features using user interface 15 and user information module 75 to the view user data stored in authorized representative list 95D showing all single company representatives that are registered with the particular manufacturer. Authorized representative list 95D may also include account balances for each of the representatives that are viewable by the manufacturer supervisors.

In some implementations, the server 25 generates emails for a particular user based on the information within the user suggestions list 95C. For instance, if a new product created by company ABC is uploaded by ABC to the server 25, the server is operable to generate and send an email or text message to another user informing that user of this information. Additionally, links to additional information, more products by this manufacturer, and/or a link to the manufacturer's website may be provided within the email. In some implementations, the product manufacturer pays a fee for such an informational email to be sent to one or more users that are associated with the manufacturer via the user suggestions list 95C.

The mailing list database 120 includes website-maintained address lists 125. The address lists 125 include at least one of email addresses and physical mailing addresses. In one implementation, the website maintained address lists 125 include address lists stored in the mailing list database 120 by website authorized personnel, such as the system administrator. In other implementations, the website maintained address lists 125 include one or more lists of addresses that are provided by users when they register to the website. Additionally, website maintained address lists 125 includes entered by representatives when registering with as a representative of a manufacturer or creating sample palettes for a customer, such as a general contractor or sub-contractor. These lists with addresses are used by the system 10 to inform a manufacturer where to ship a requested product sample. For example, after a user creates a palette 45 and requests a sample of the products in the palette, the system 10 sends a sample delivery request to each manufacturer. The sample delivery request includes information about the product and the shipping address of the requesting party. In addition, the address lists stored in the mailing list database 120 are used to send invoices to manufacturers.

In another embodiment, when a user 40 saves a product, the manufacturer is notified that someone has viewed and saved one of their products. If the manufacturer wants to receive details about who saved their products and perhaps pays a particular fee, the manufacturer receives an email from the system with the information about the user that saved their product. The transaction is handled by the payment module 86 similar to other e-palette transactions.

The representative database 131 representative store representative information on registered representatives, manufacturers, and manufacturer supervisors. In some implementations, data stored representative database 131 may overlap with authorized representative list 95D, or authorized representative list 95D may be a data component stored in representative database 131. Additionally, the interface also allows representatives to download client list to the system so that representatives may quickly popular client information when submitting sample palette orders and individual orders. Representatives' client lists are stored to the representative database 131 and may be accessed, reviewed, and filtered by a representative using a number of interface elements or menu options. Additionally, client lists may be automatically accessed when a representative is creating an order or sample palette for submission in order to populate representative orders with client information.

The filters database 141 stores a set of filters that gives representatives access to a unique and complex filtering system for a vast variety of architectural materials. Filters database 141 stores filters that allow representatives to filter and sort architectural materials by aspects of the material beyond what may be traditionally displayed to a user. In particular, construction standards often specify particular requirements to be satisfied for a material, design, product, or service. If a particular material fails to meet these criteria for a particular application or use, the material may be considered out of specification and may not pass grades. While these standards often set basic, minimal classifications for materials based on classes of material use, performance and safety requirements, features, etc., these standards often change and are dependent on the particular context of the user. Moreover, a particular general contractor or sub-contractor may have specific requirements for a particular piece of equipment. These requirements may go beyond the minimal specifications set by a standards setting organization. This presents a significant barrier when representatives seek to provide a sample palette potentially containing multiple products, for multiple sub-contractors, having multiple specifications, and potentially being made by multiple manufacturers. In particular, ensuring the products meet the particular specifications can take a significant amount of time and is a very slow, labor-intensive that typically requires calling numerous manufactures to discuss numerous products with each.

Some implementations of the present address these issues by providing a technical database of highly complex filters that allow representatives to quickly narrow down classes of products based on a range of categories and product features. Each filter set is customized to a specific product type or field of products and includes the particular filters that may be relevant to a representative or contractor when attempting to locate a product that meets certain specification requirements in a particular field or use. For example, independent filter sets may be provided for products categories including brick and tile, building products (e.g., beams, headers, joists, columns, floor panels, lumber, etc.), cabinetry, ceiling material, coatings, commercial kitchen equipment, concrete pourings, curtain walls, decking, doors, drains, drapery and shades, drapery hardware, electrical switches, exterior cladding, fireplaces, furniture, hardware, health products, heating, insulation, laminate, lifts and elevators, lighting, metals, mood boards, paint, panels, paper, photo engraved products, seating, signage, solid surface, stairs, stone, sustainable products, trimmings, veneer, wall protections, waterfalls, wires, wood mouldings, woven vinyl products, and so forth. Each product category will raise a unique set of considerations that may be addressed by the respective filter set. As will be apparent to one skilled in the art, these filter sets are cover a vast array products having divergent characteristics and uses, and each requires an independent and customized set of filters in order to provide manufacturers and representatives with the ability to quickly and efficiently narrow products by relevant specifications.

Moreover, the filters are provided in a hierarchical format of categories and features that are arranged according to levels. At the first level, each set of filters may have a common set of filtering categories that are applicable to all or most products of every filter set (e.g., application, price range, color, shipping destination, etc.). However, while each filter set would share these first-level categories in some embodiments, the list of available filtering criteria made available under each category would nevertheless be tailored to specific product category. For example, one product (e.g., lighting) would have different filtering categories under the first level than would be available for sorting a second product (e.g., art). This may be true at each of the described levels of filtering. As a second level of filtering, each filter set for the product categories may have some product-specific filtering sets that are designed to allow manufacturers to quickly identify product characteristics that are relevant to particular construction specifications or standards. For example, a specification for a particular construction job may require insulation that meets a required life expectancy, meets a certain Volatile Organic Compound (VOC) emission, or is recyclable upon the end of its life. These product-specific filter sets may be unique to the product category, but may be required to meet certain standards of a particular code, regulation, or contractor specification. In some embodiments, a second level of filters is designed to capture these product-specific specifications.

A third set of filters is also provided for each product category and may itself consist of a number of filtering levels, as may be required for the particular product category. In some embodiments, the third set of filters is designed to capture all functional aspects of a particular product set. The functional aspects include all of the relevant features that may be used to differentiate the products falling within the particular category of products, such as capacity, power usage, desired features, and so forth. This set of filters allows a manufacturer or representative to narrow down the list of available products to choose from based on those having a desired component or operational feature. Similarly, a fourth level of filters is provided for each product category that includes any aesthetic or non-functional aspect of the product category that may be relevant to particular representative. For example, a representative looking for a particular product to meet the design parameters for a particular jobsite can utilize these aesthetic filters to display only those products meeting a particular design element or consideration.

Although the filter set is described as having four levels, a person of skill in the art would recognize that these filter levels may be conceptually divided into a number of arrangements and levels without departing from the scope and spirit of the present description. Through the use of the hierarchical levels of filters, however, the website provides a comprehensive list of highly customized and product-specific filter sets that are allow representatives to narrow displayed products by features and specifications that are particular to products in a given category. In order to illustrate the complexity of the filter sets, in some embodiments, the categories and levels may include, as non-limiting examples, product features ranging from intended product use, manufacturer, supplier, geographic area of manufacture, particular specialty uses, aesthetic or cosmetic features, functional features, product design, price, size, weight, power usage, safety specifications, recycled content certifications, health department classifications, accessories, life expectancy, final assembly location, available add-ons, production rate, capacity, and so forth. These filters are customized to both the particular product and its characteristics, as well as based on the range and types of construction specifications or requirements that may be required with respect to each product. Utilizing these unique and comprehensive set of filters, representatives are able to quickly and efficiently generate product orders and sample palettes meeting the individual specifications associated with a particular job, work site order, or individual order.

As one example of filtering a particular category, a filter set for commercial kitchen equipment may include a first level of filters for application (e.g., commercial or residential), price, color, shipping destination, interior/exterior, environmental attributes (life expectance, assembly location, end of life options, REDLIST materials, VOC levels, cycled content, health product ratings, warranties), and so forth. Commercial applications may be further broken down in filters based on corporate, cultural, educational, government, healthcare, hospitality, institutional, preservation, retail, sports/recreation, and transportation uses. As an exemplary second level of filters, product-specific filters for kitchen equipment may include categories based on product type, such as ovens, stoves, broilers, hot plates, fryers, char broilers, griddles, specialty products, hoods and fans, refrigerators and freezers, bar equipment, ice machines, dispensers, filtration, food holdings and buffets, warmers, sinks, stands and tables, warewash, coffee and cold beverage dispensers, and/or coffee and tea brewers. Furthermore, third, fourth, and additional levels of filters may be associated with each of these second level categories as may be appropriate for the particular product-specific filter set. For example, functional product features for refrigerators may be further broken down by standards and product features for relevant to reach-in freezers, roll-in freezers, pass-through freezers, undercounter refrigerators, bar refrigeration, etc. Each of these may third-level filter sets may then be broken down by aesthetic features, such as number of doors, door type (full versus half), display, glass, width, height, depth, volume, stainless steel, aluminum, door shelving, etc. While these illustrations of the various filter levels are merely exemplary, one of skill in the art would appreciate the complexity of the filter set and that the comprehensive filter set described herein allows manufacturers and representatives to quickly and efficiently filter products to locate products meeting particular specifications and requirements of a given construction contract or other need.

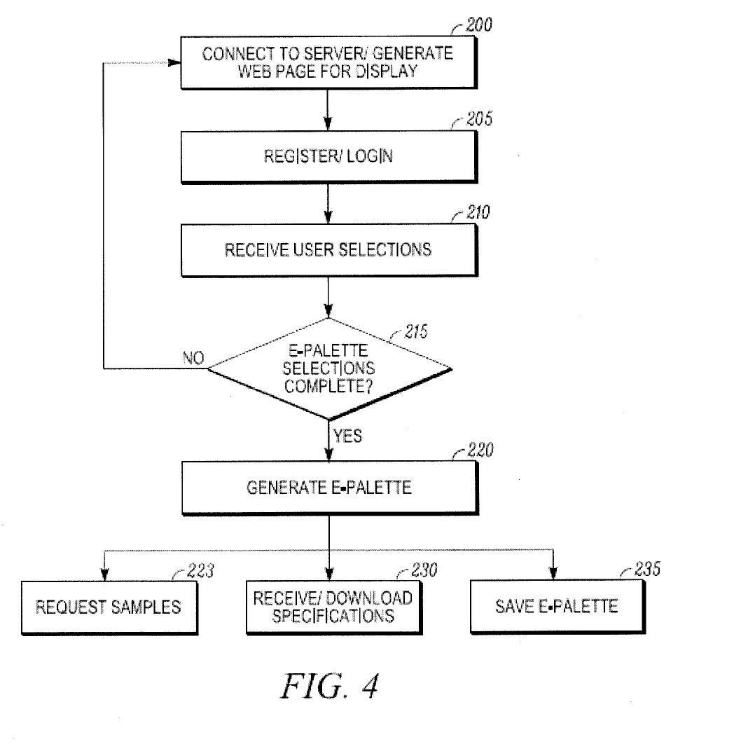

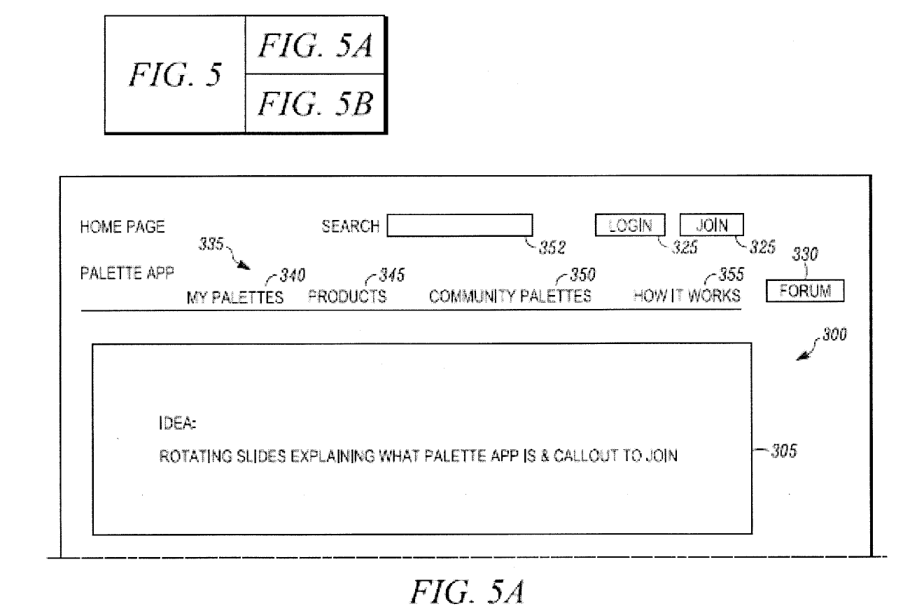

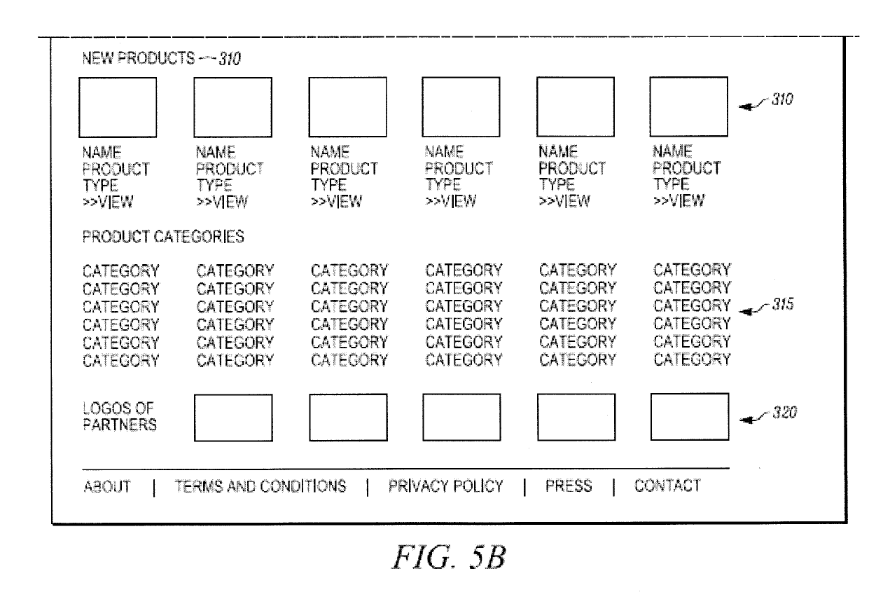

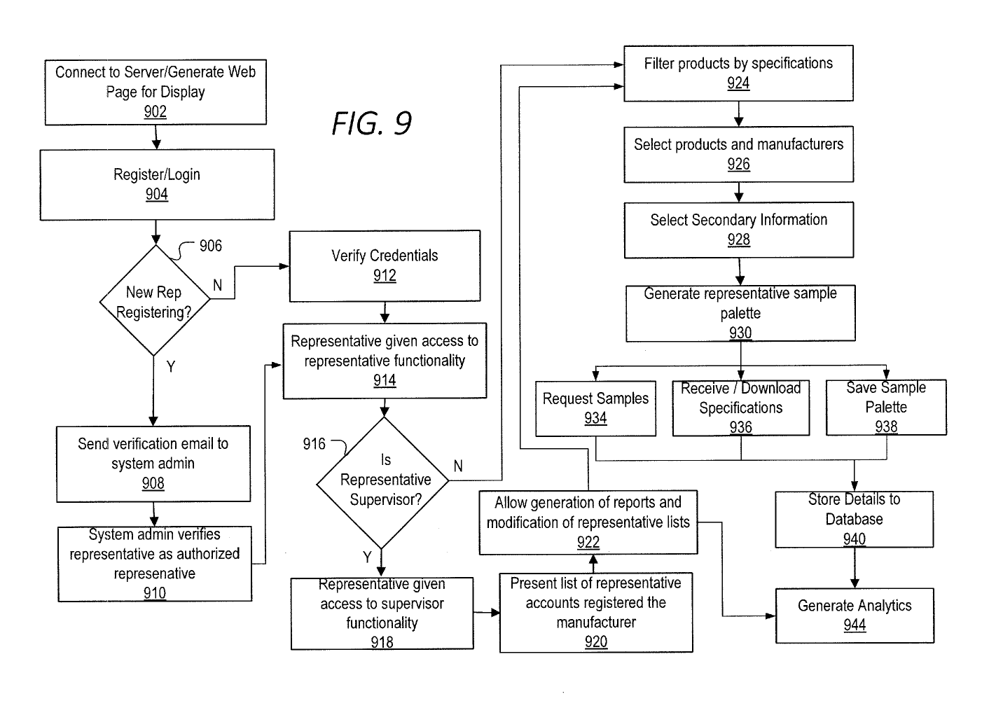

FIG. 4 depicts a method of generating an e-palette according to embodiments of the invention. In some embodiments, the similar steps to those depicted in FIG. 4 may be utilized by a representative accessing the system, although the representative user will have additional functionality available to them, such as functionality allowing the representative to create sample palettes for manufacturers. In step 200, the user 40 connects to the server 25. In one instance, the server 25, in particular, the webpage module 60 and related webpage circuitry generates webpage data for display in a web browser 50. The webpage data is sent to the user's web browser, for instance, over the Internet 20. Once received, the webpage data is displayed in the web browser 50, and at step 205, an exemplary home page (FIG. 5) is displayed in the web browser 50 based on the webpage data generated. In step 205, a user 40 creates an account or logs in into an existing account. To search products, create e-palettes, and order samples of products, a user 40 must be registered with the website. In some embodiments, a visiting user is able to search and view products but he will not be able to create an e-palette or request product samples unless he or she is registered. Similarly, representatives that have registered but have not yet received administrator approval, as discussed further in connection with FIG. 9, will not be able to submit sample palettes until the representative has been authorized as a representative of at least one manufacturer.

In step 210, the user inputs information via the user interface 15 to the server 25. The user interacts with the server 25 via the web browser 50 and the server responds to the user-entered information and outputs updated webpage data accordingly. The information entered by the user 40 may include selection information (e.g., selection of an e-palette template), commands (e.g., search products, generate e-palette), and/or user information (e.g., login, password, or information for user information database 95). This interaction between the user, user interface 15 and related interface circuitry, and server 25 is commonly referred to as “browsing.” Browsing the e-palette website refers to the webpage data collectively generated, stored, and output by the server 25. Browsing the website typically involves a number of system circuitry components in operative communication executing tasks, for example, to generate content and implement functionality. Browsing includes, among other things, logging into the website, creating e-palettes, browsing e-palettes, browsing products, and browsing manufacturers. Tasks and functionality implicated while browsing is usually handled by one or more interface circuitry to receive inputs and display content to the user, such as via interface 15, sample palette generating circuitry to generate and store palettes of products, filtering circuitry to search and filter product results, as well as stored data for users and palettes, analytics circuitry to process reporting data related to palettes, products, and respective manufacturers, display logic circuitry to generate logic for displaying graphical interface elements described herein, as well as other circuitry. Steps 200 and 210 are repeated during this browsing period until, in step 215, the server 25 receives the information necessary to generate an e-palette.

In step 220, the server 25, in particular, the e-palette generating module 70 and related palette generating circuitry, generates an e-palette 45 based on the user information entered. After the e-palette is generated, depending on the embodiment of the invention and the particular e-palette generated, the user 40 may request a sample of every product in the created e-palette (step 223) that will be processed and handled by respective request circuitry. In one embodiment, a product manufacturer may be charged a fee for every sample product ordered through the website. The server 25, in particular, the payment module 86 and related payment circuitry, carries out the purchase transaction. In an alternative embodiment, a user 40 can download or receive a specification sheet (e.g., a PDF file) for every product on the created e-palette. Thus, in step 230, a PDF file including the product's specification sheets is sent by the server 25 to one of the recipient interfaces 15 or the user's email on file. In yet another embodiment, in step 235, the user 40 can save his or her e-palette and product selections (e.g., into the user's libraries) without requesting samples and/or specifications sheets.

As mentioned above, FIG. 5 depicts web browser 50 with one exemplary layout of the e-palette website homepage 300. The homepage 300 includes an information section 305 (i.e., used to explain the general idea of the website), new products section 310, products categories section 315, and a partner's logos section 320 (e.g., sponsoring partners). Further, the homepage 300 includes a login/join section 325, a forum section 330, and a toolbar section 335. In some implementations, after a user 40 logs on to the website using login section 325, which interacts with the server 25 to verify the user's identity as described above, the components of the website are updated with customized webpage data. In some implementations, cookies stored on the user interface 15 from a previous webpage visit are automatically used by the server 25 to verify the user's identity without requiring login actions. In other implementations, a user is also able to browse without logging on to the website.

In one embodiment, a user chooses a browsing option by selecting one of the following buttons in the toolbar section 335: my palettes 340, products 345, community palettes 350, my libraries 351, search 352, how it works 355, and social 356. In alternative embodiments, the toolbar section 335 can include more or less buttons. If a user selects the search button 352, the user will interact with the e-palette website to view various products by different manufacturers. FIGS. 6AA-6GB illustrate a portion of the various webpages used to search products in the website and to create an e-palette. Similar feature and interface elements as shown in FIGS. 6AA-6GB are used by representatives to search products for particular manufacturers and to create sample palettes; although, as described further in connection with FIG. 9, representatives have access to a separate component of the website where they can make use of additional features and functionality that may not be available to common users.

The user can search or view the different types of products offered on the website by clicking on the products tab 345. FIGS. 6AA-6AB illustrates an exemplary webpage that includes a products window 369 representing the different groups of products 370 (e.g., flooring, tiling, hardware, metals, wall finishing etc.), a new products window 371, and a product categories window 372. Some of these categories of product include various subcategories (e.g., tiling—ceramic, porcelain, mosaic etc.; fabric—cloth, leather, panel fabric, etc.). The user can simply click on the desired product group 370 in order to view the selection of products. The products are stored in the products database 100. Additionally, as shown on FIGS. 6BA-6BB, the user can view a specific product and narrow a selected product group 370 by using the product type, manufacturer, price color, or application. Registered manufacturers can access the server 25, upload new products, and update the information on existing products. The manufacturers provide specific information (e.g., product data, specification sheet, etc.) and photos of each new product and receive a confirmation email from the system when a product image or information is uploaded to the products database 100 and is ready to be viewed by users 40. Most likely, each product group 375 will include large selection of products (e.g., 100-1000). Therefore, a user 40 will utilize the search button 352 to display a search page (FIGS. 6CA-6CB) in order to search various products by different manufacturers.

As shown in FIGS. 6CA-6CB, the search page allows a user 40 to browse, search, and view or preview specific products stored in the products database 100. For that reason the search page includes a product search window 380 and a product display window 395. In some implementations, the user inputs the product information in a product drop-down menu 385 (e.g., flooring) and specifies the specific product sub-category in the product category menu 386 (e.g., hardwood). In addition, the user can select a specific manufacturer from the manufacturer menu 387, price or price range for the product from the product price menu 388, product color from the color menu 389, and application (e.g., commercial, residential, etc.) from the application menu 390. In some implementations, the searchable data (e.g., products) are associated with keywords in their respective databases.

After entering the desired search criteria, the user commences the search by selecting the search button 39. The web browser 50 sends the search request to the server 25, which ensures that the search request is in the proper format, and forwards the request to the databases 30. The databases 30 receive the search request. In particular, the filtering module 65 and related filtering circuitry searches the products database 100 based on the entered search criteria. The database 100 returns the results back to the server 25, which ensures that the results are in the proper format, and forwards the data to the web browser 50. The results from the search are displayed in the product display window 395. Upon selection of a particular product, the display window 395 provides a preview to the user of the selected product. If a user already has an e-palette 45, the user can add a product from the product display window 395 to that e-palette 45.

In addition, a product can be viewed by opening a new webpage. FIGS. 6DA-6DB shows product detail page 410 that includes a product image 415 and a product information window 420. The product detail webpage 410 can also include a “more items” window 419 that shows similar products from the same manufacturer. Further, a user can add one or more products to a user's library 400. For example, a user can create different libraries 400 for the different projects and product groups 375. In these libraries, the user can add e-palettes and products that he or she likes and wants to use in the future. The user 40 can delete a library or products within the library at any time.

In one embodiment, a user can view and select from thousands of existing palettes saved in the e-palette database 90. A user can access the saved existing palette templates by clicking on the “community pallets” tab 350. As shown in FIGS. 6EA-6EB, the community palettes page includes a palette search window 421 and a palette display window 422. The palette search window 421 includes search menus 385-390 similar to the product search window 380. After the system 10 sorts the community palettes by using the filtering module 65 and related filtering circuitry, the user can view the community palettes in the palette display window 395. The user can select any of the exiting palettes and modify it according the specific needs of his or her projects. In some embodiments, the community palettes also include e-palettes that are created by other users and are publicly available.

In order to view saved palettes or to create a new palette, the user clicks the “my palettes” button 340. On the “my palettes” page 405 (see FIGS. 6FA-6FB), the user can see any previously created and saved palettes that are located in the palette libraries database 105. The user can open every palette, view the products in the palette, and add or remove products in the palette. Further, from the “my palettes” page, the user can delete existing palettes, or duplicate palettes and save them under a new name. In addition, the user can create a new palette 45. After clicking on the “create new palette” button 425 from the “my palettes” page 405, a new palette window 430 opens up. As shown in FIGS. 6GA-6GB, the user enters the required information in the following fields: title 431, type of project 432, budget 433, description, 434, primary color 435, secondary color 436, and tags 437. The user can specify whether the palette 45 is public or private.

In one embodiment, after inputting the palette information, the user is presented with e-palette template options. Based on the inputted palette information, the server 25 generates a list of suggested e-palette template options. The server 25 generates the list by using the received palette information to access the e-palette database 90. For example, the suggested list of e-palette templates can be displayed in the webpage or included in a drop-down menu. In some implementations, the webpage includes an e-palette preview window. When an e-palette template is selected from the user, a preview of the e-palette template is generated by the server 25 and displayed in the e-palette preview window. A user 40 may select an e-palette template and proceed to customization options by selecting a customize button.

The e-palette generating module 70 and related palette generating circuitry generates e-palettes for saving into the user's libraries or providing to a user computer 15. The e-palette generating module 70 and related palette generating circuitry receives the components to build an e-palette based on user selections via the e-palette website as described above, for instance, with respect to FIGS. 5-6AA-GB. A portion of the data received includes an e-palette template from the e-palette database 90. In some implementations, the template specifies the product groups 370 of the e-palette (e.g., flooring, fabric, hardware etc.), the specific products (carpet, laminate, cloth, leather), and the number of products for each product group (two carpets options, three fabric options, one glass option, etc.). In other implementations, the palette template includes only the product groups and a user 40 is able to modify the specific products, number of products, and other characteristics of the e-palette. The specific product associated with the e-palette template are sent from the products database 100 to the e-palette generating module 70, either by a specific request from the e-palette generating module 70 or automatically by the products database 100 upon selection of a template. The e-palette generating module 70 and related palette generating circuitry also receives recipient information and user specified details, such as palette title, type of project, and overriding information, sent from the user interface 15.

In some implementations, the designer user can modify a created e-palette 45 (during creation or after the palette is created) by adding products that are not stored in the products database 100. For that reason, the user uploads a product and saves it to the system 10 (e.g., in the products database 100). In order to upload a new product, the user must upload an image of the product and include information about the product (e.g., title, description, category, manufacturer, color, cost, etc.).

After receiving the information to generate the e-palette, the e-palette generating module 70 and related palette generating circuitry assembles the e-palette 45. An exemplary e-palette 45 is depicted in FIG. 7. The e-palette 45 includes image of various products (e.g., carpet 505, hardware, 506, colors 507-508, fabric 509, and laminate 510). By using the toolbar 500, the user can further modify the e-palette 45 by adding, changing, or deleting products. The user can also delete or duplicate the created e-palette 45. Further, by using the palette action buttons 520, a user 40 can view product specifications, order samples of the products, share the palette, or view project details. In addition, the user 40 can move, layer, resize, and sort the product images displayed on the browser 50 in order to modify the palette 45.

Once the user is satisfied with the generated e-palette 45, the server 25 proceeds to save and/or deliver the palette 45 as requested by the user 40. Delivery method options include sending the e-palette 45 as an attachment (to an email address), downloading the e-palette 45 to a user computer 15, or posting it to a social networking website.

Upon receipt of the e-palette 45, a user 40 views the e-palette 45 via an e-palette reader (e.g., a web browser, specific email application, or other html interpreting device) and a display (e.g., a monitor). The user 40 is also able to save the attached e-palette in a local memory of the user's receiving device, e.g., a hard drive of the user's computer. Thereafter, the attached e-palette 45 is operable to be opened by the user without a connection to the Internet 20, since the file is stored on a local memory device.

In some embodiments, the user 40 receives an e-palette 45 on a mobile computing device, a mobile phone, tablet computer, laptop, netbooks, etc. In some embodiments, an e-palette is sent as a text message (e.g., a multimedia message (“MMS”)).

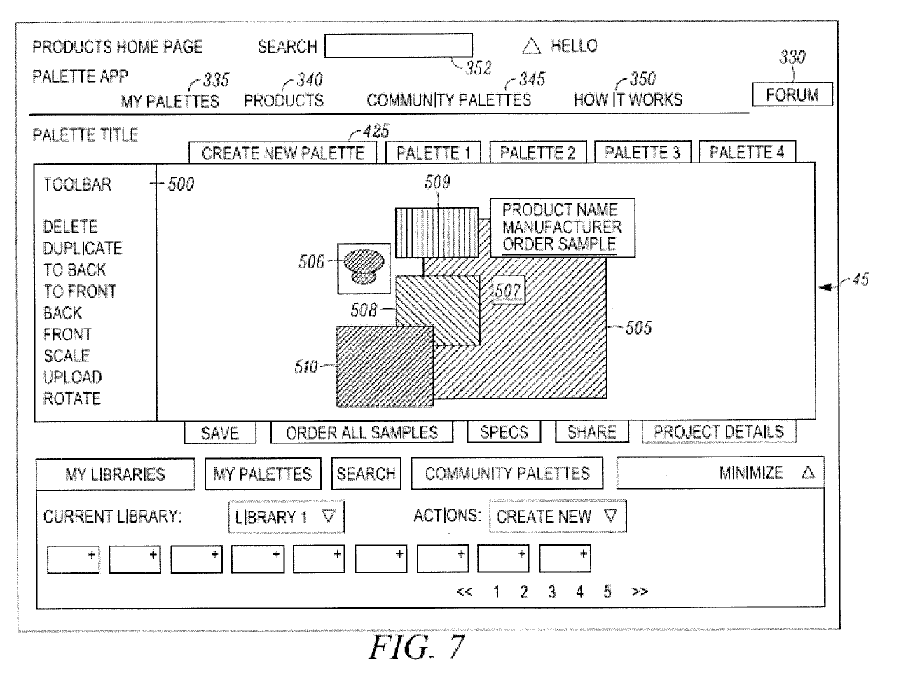

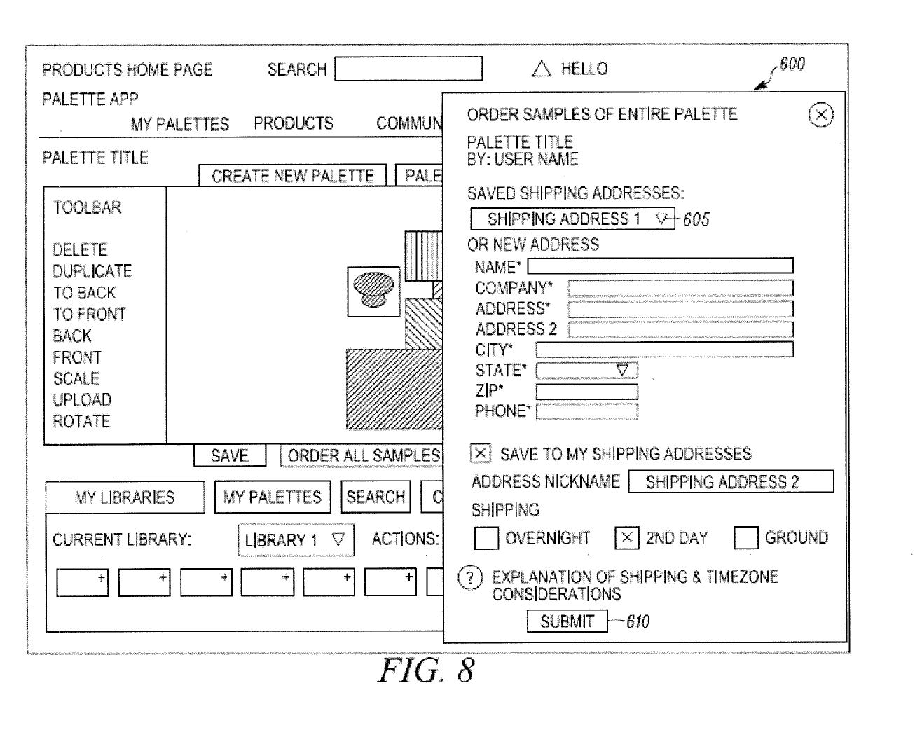

In one implementation, the user 40 can order samples for the products included in the created e-palette 45 from the system 10. When the user clicks on the order samples button 525, an “order samples” window 600 opens up. As shown in FIG. 8, the user 40 can select a shipping address from the drop-down menu 605 or enter a new shipping address. The user can also select the shipping method (e.g., overnight, ground, etc.). When the user hits the submit button 610, the communication module 80 sends an email to all manufacturers of the products included in the palette 45. The email includes information about the requested sample(s), address of the receiving party, and the specified delivery method. A record of each sample order is stored into the orders database 121 for tracking purposes, manufacturer invoicing, and reporting. Of course, the user 40 can also order product samples for individual products that are not included in the palette 45 by following a similar procedure and requesting samples from manufacturers via the e-palette website. In some embodiments, orders database 121 also contains reporting data related to palettes and manufacturer orders submitted by independent representatives and company representatives.

If a product sample cannot be ordered or delivered (e.g., manufacturers can restrict certain users from ordering samples), the system 10 sends an email to the user 40 including the contact information of the manufacturer. In one implementation, when the user is a manufacturer or a representative, that user will be able to only display products for the specified manufacturer that they work for.

Although the invention is described for use with a user interface 15 and with a web browser 50, in some embodiments, a user interacts with the server 25 as described above using a mobile device, in-store kiosk, or other electronic device with either a web browser 50 or an e-palette software application being executed thereon. For instance, in some embodiments, a user navigates the e-palette website using a mobile computing device using either a web browser or a specific e-palette application that facilitates e-palette generation as described herein.

FIG. 9 shows exemplary operations that may be performed when registering representatives with the system and allowing representatives to generate product orders and sample palettes. In some embodiments, one or more of the operations and respective functionality may be provided or left out without departing from the spirit and scope of the present description. Additionally, the functions and operations described in connection with FIG. 9 may be performed by various aspects of the website as already described herein, including the modules 26 of server 25, and their respective circuitry, described in connection with FIGS. 2-8.

At block 902, a representative connects to the server 25. In one instance, the server 25, in particular, the webpage module 60 and related webpage circuitry and/or display logic circuitry, generates webpage data for display in a web browser 50. The webpage data is sent to the representative's web browser, for instance, over the Internet 20. Once received, the webpage data is displayed in the web browser 50 including based on the webpage data generated. At block 904, the representative registers to create an account or logs in into an existing account. In some embodiments, if the system determines a new representative is registering an account, then at block 906 the system sends a verification email or alert to an administrator associated with the website at block 908. The administrator may be required to review the representative information provided at block 904 and to approve the representative as authorized. If the representative is an independent representative then the administrator may administrator can validates the data provided by the independent representative and confirms the companies that they are representing. If the representative is registering as a single manufacturer representative, then the admin may be able to check a list of authorized representatives associated with the manufacturer, which may be stored authorized representative list 95D. If the representative is listed on the authorized representative list 95D, then administrator can approve the representative as a manufacturer representative. The administrator submits the verification at block 910.

If the representative was a login into an existing account at block 906, then the system may verify the credentials of the representative at block 912. Once verified, the system may give access to system functionality to the representatives. At block 916, the system may determine if the representative is a supervisor representative associated with one of the manufacturers. At block 920, supervisor representatives will be able to access and view lists of all representatives that have registered as manufacturer representatives, as well as add, delete, or otherwise modify lists of representatives at block 922. Also at block 922, supervisor representatives may view historical data related to the activity of their representatives, including prior orders, saved palettes, statistical data on production, customer contact lists, and so forth. Analytics tools may also be made available to the supervisor representatives to allow them to quickly analyze and generate system reports detailing representative performance information at block 944. Both supervisor representatives and other representatives will have the ability to search products, create sample palettes, and order samples of products. In some embodiments, a representative is able to search and view products after they have registered an account but he will not be able to create a sample palette or request product samples unless he or she is registered and/or approved by the system administrator.

At block 924, the representative inputs information via the user interface 15 to the server 25. The representative interacts with the server 25 via the web browser 50 and the server responds to the user-entered information and outputs updated webpage data accordingly. The representative may initially information used to filter the displayed products based on or more criteria. As previously described, some embodiments provide representatives with access to a technical database of highly complex filters that allow representatives to quickly narrow down classes of products based on a range of categories or order specifications. These filters are highly customized to both the particular product and its characteristics, as well as based on the range and types of construction specifications or requirements that may be required with respect to each product. Utilizing these unique and comprehensive set of filters, representatives are able to quickly and efficiently filter displayed products at 924 by selecting the highly customized features.

At block 926, the representative selects the products and/or manufacturers that the representative would like to add to or associate with the sample palette. At block 928, the representative specifies additional secondary information that may be associated with each sample palette. In some embodiments, before an order can be placed, the manufacturer's representative must fill in certain data, such as project name, location, and size of project, as well as any particular specifications or requirements associated with the project. The representative can select from a drop down menu the client's firm name and client's name. The drop down menu may automatically be populated with client information from client lists, such as those imported and stored in the representative database 131. The representatives can also fill in the general contractor information, sub-contractor information, owner's representative, and budget prior to the request being processed, or in some embodiments, may provide this information at a later time.

At block 928, the system also provides the representatives the ability to request multiple samples, project binders, specification sheets, warranty sheets, maintenance sheets, installation instructions and MSDS sheets, price lists, technical brochures, product brochures, and product sample books from one or multiple manufacturers. In some embodiments, these items and the respective products may be added a drag and drop system, regardless of whether the representative is connected to Wi-Fi or not. At block 930, all of the items specified are added to the sample palette for the representative and the server 25, and in particular, the e-palette generating module 70 and related palette generating circuitry, generate a sample palette. The manufacturer's representative can also create electronic sample palettes featuring products that they sell along with coordinating products.

After the e-palette is generated, depending on the embodiment of the invention and the particular sample palette generated/options selected by the representative, the system may automatically request a sample of every product in the created sample palette (at block 924) that will be processed and handled by respective request circuitry. In some embodiments, the representative (or their respective manufacturer) be charged a fee for every sample product ordered through the website. In other embodiments, the manufacturer (or independent representative) may pay a yearly subscription fee, which may be calculated based on the number representatives associated with the particular manufacturer. The server 25, in particular, the payment module 86 and related payment circuitry, carries out the transaction and generates periodic bills. Additionally, in some embodiments, the representative (or their supervisor or the administrator) can download or receive a specification sheet (e.g., a PDF file) for every product on the created sample palette at block 936. At block 936, a PDF file including the product's specification sheets is sent by the server 25 to one of the recipient interfaces 15 or the representative's email on file. In yet another embodiment, at block 938, the representative can save his or her sample palette and product selections (e.g., into the representative's or manufacturer's libraries) without requesting samples and/or specifications sheets. Additionally, in some embodiments, all three options or combination thereof may be available to the representative and/or manufacturer, including after the order is completed.

At block 940, each order, saved palette, or requested sample is stored to one or more master databases, such as databases 30. The databases allow the representative and his/her superiors the ability to access the interface to sort the data in numerous formats and based on any parameter that they desire. In some embodiments, all information for every order submitted or saved is automatically stored to a CRM database and may be searchable or accessed by manufacture representative (and/or administrators) to generate analytics reports. For example, in some embodiments, the data for past orders, saved palettes, and requested samples can be sorted by representative, region, product type, color, territory, style, product feature, etc. By sorting this data, the representative and their manufacturer are able to see trends in both the order history, as well as in the design and color (or other product features) of the products requested. At block 944, the representatives and their supervisors may generate analytic reports detailing this information and the requested sorts. The analytic reports allow the representatives and their supervisors to track productivity of the sales representatives in order to generate metrics gauging representative performance, as well as forecast potential demand, which may be used for projecting future orders, among other things.

Each of the aforementioned tasks discussed in connection with FIG. 9, including, among other things, logging into the website, creating sample palettes, browsing saved sample palettes, browsing products, browsing manufacturers, and generating analytics reports, is usually handled by one or more system circuitry components working in conjunction interface circuitry and display logic generating circuitry to generate and display a user interface for performing the tasks to the user. For example, in some embodiments, the system circuitry receives inputs and display content to the user, such as via interface 15, the interface circuitry is in operative communication with sample palette generating circuitry to generate and store palettes of products, filtering circuitry is used to search and filter product results, as well as stored data for users and palettes, analytics circuitry is used to process reporting data related to palettes, products, and respective manufacturers, display logic circuitry is used to generate logic for displaying graphical interface elements described herein, as well as other circuitry executing other tasks described herein.

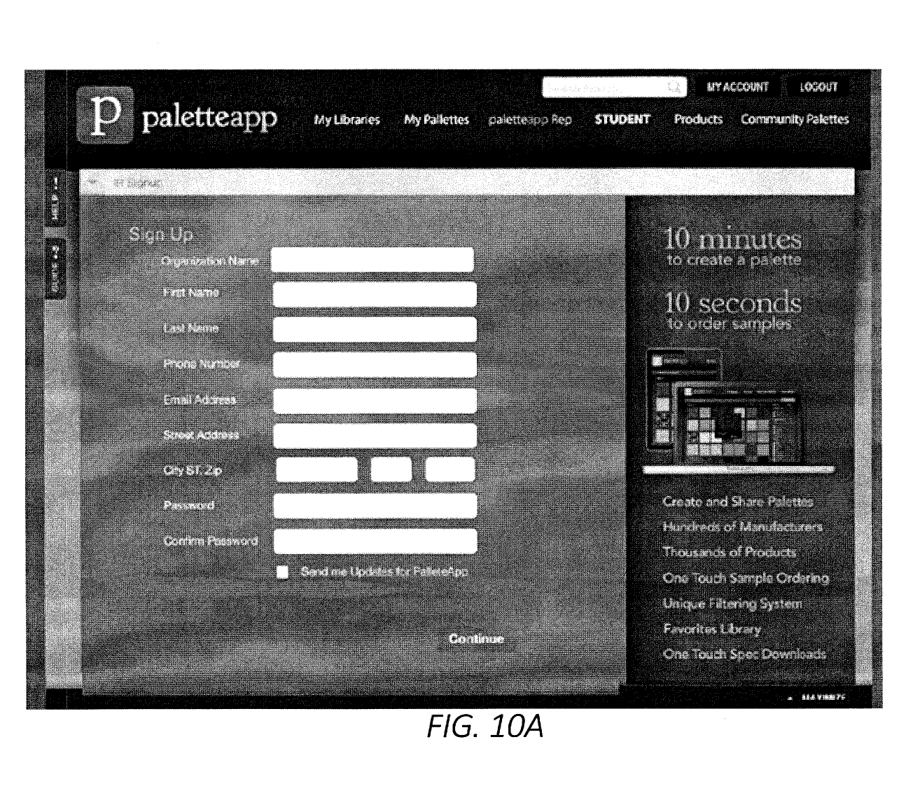

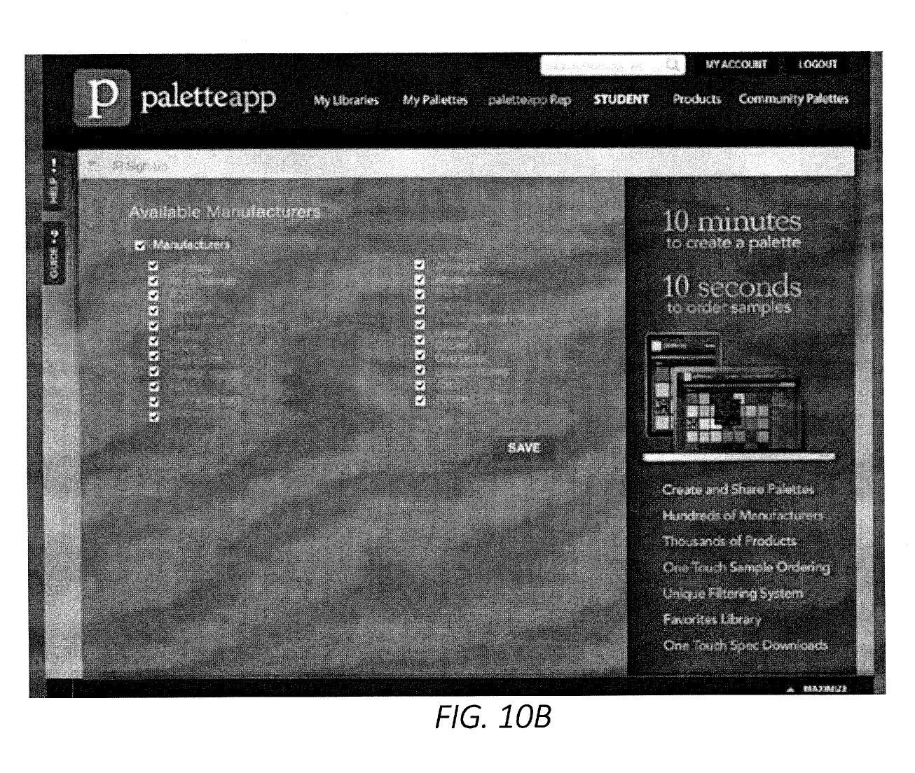

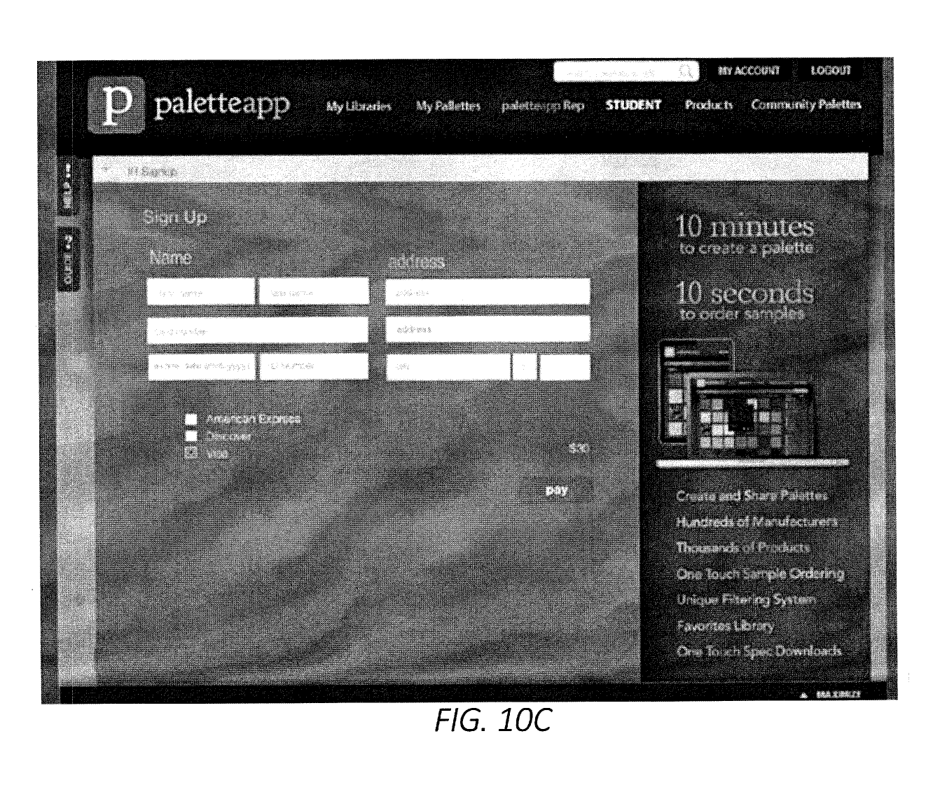

FIGS. 10A-12 illustrate exemplary interfaces of a website implementing various aspects of the electronic sample palette website generated by the server of FIG. 2 according to some embodiments. These exemplary webpages may be used in one or more of the embodiments described herein to implement a portion of the functionality described in connection with FIG. 9. However, as will be apparent to those of skill in the art, these webpages are merely exemplary and modifications may be in various embodiments that are still intended to be covered within the spirit and scope of the present description. FIGS. 10A-10C show exemplary screenshots of webpages or interfaces of an exemplary electronic sample palette website according to some embodiments that may be used by independent representatives to register with the site. Referring now to the exemplary interface of FIG. 10A, this interface will allow independent representatives to register with the website and input information, such as Organization Name, First Name, Last Name, Email, Address, and Password, among others. In some embodiments, the independent representatives may then proceed to another page to select one or more companies that represent, as illustrated by the exemplary screenshot of FIG. 10B. As described in connection with FIG. 9, before independent representatives can start to order samples, the system may require verification with each manufacturer that the independent representative has authority to represent the manufacturer. Once verified, however, the independent representatives are authorized with the system and a confirmation can be generated sent to the representatives registered contact information. The individual representative may set up payment information as illustrated in FIG. 10C, for example. In some embodiments, the individual representative may pay for their subscription via credit card payments that are billed monthly.

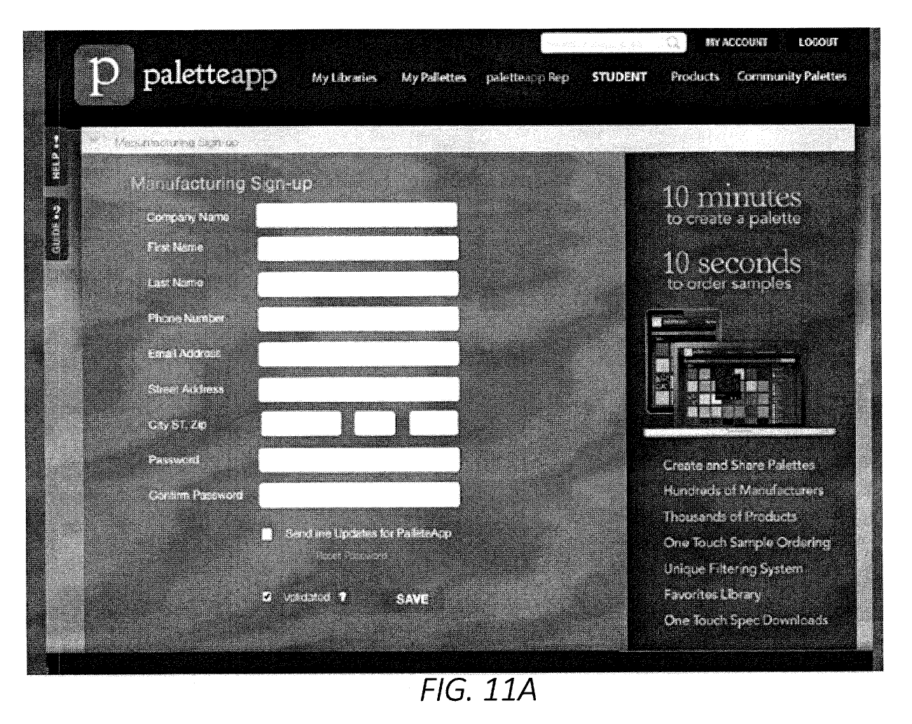

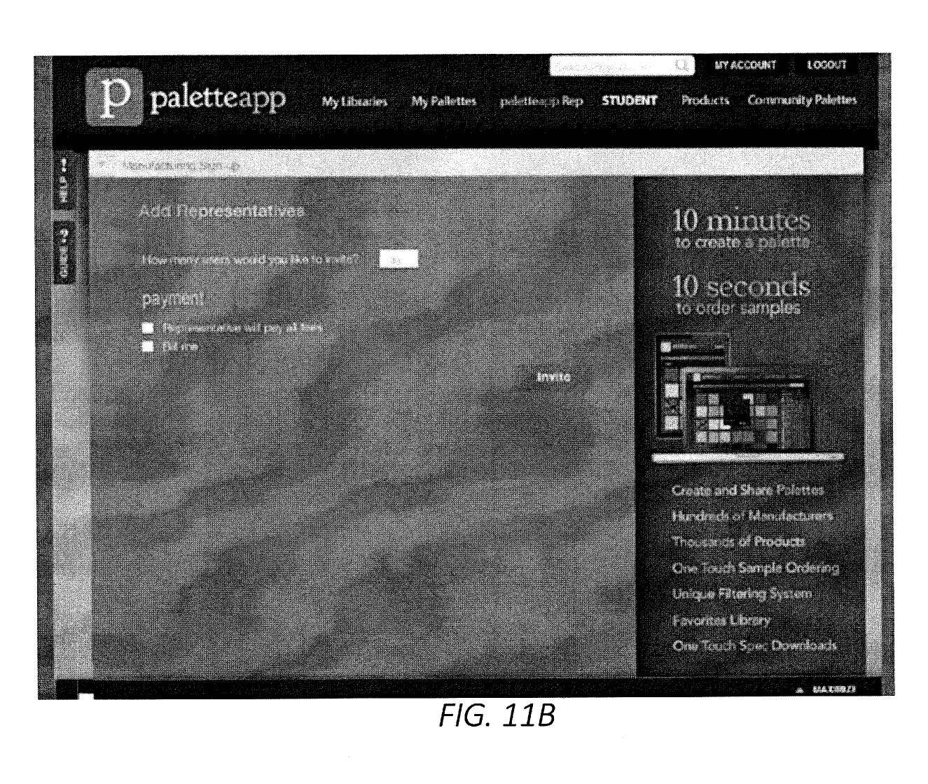

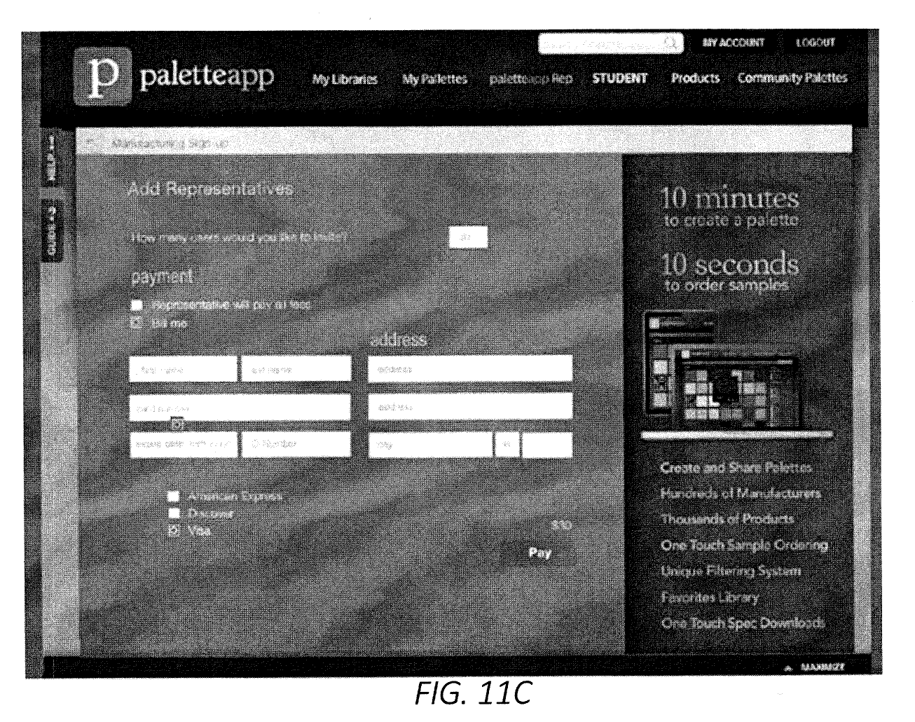

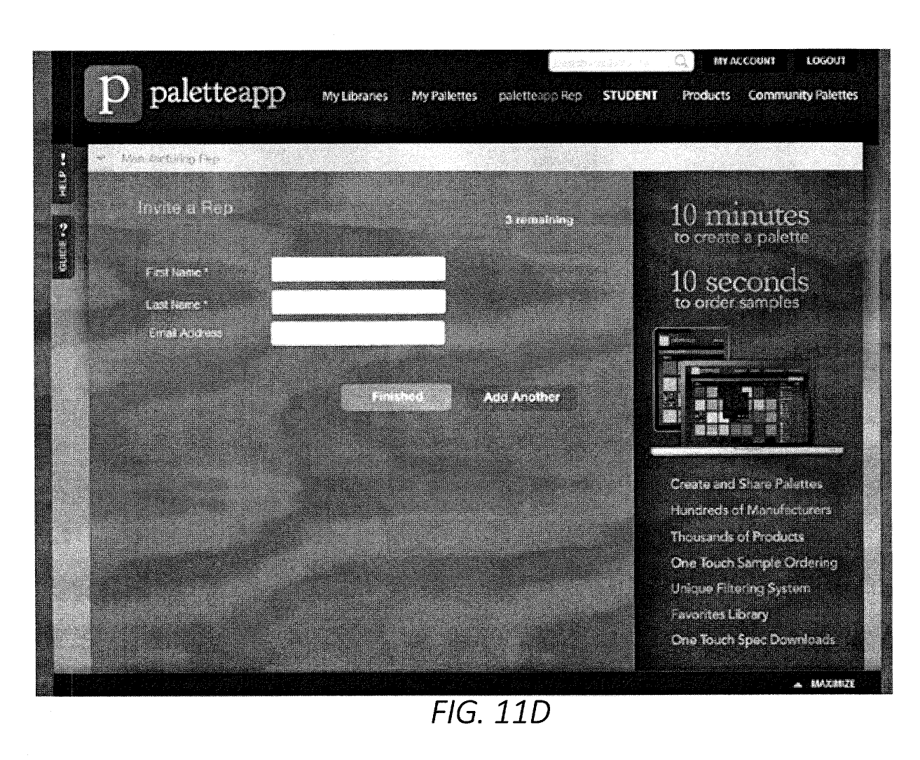

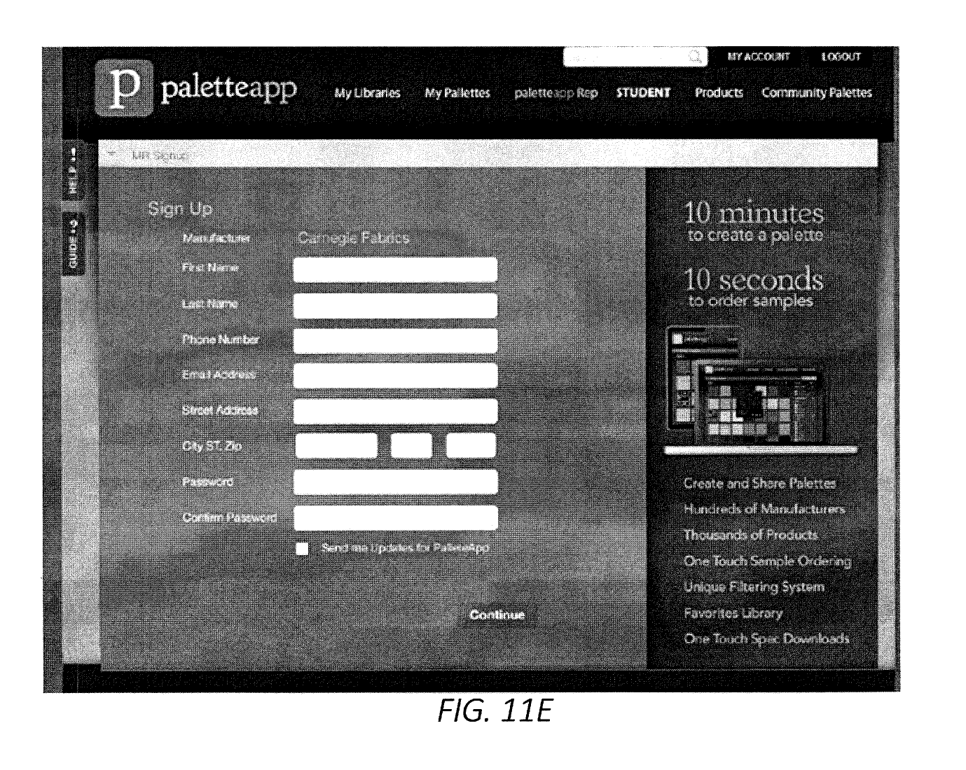

FIGS. 11A-11E show exemplary screenshots of webpages or interfaces of an exemplary electronic sample palette website according to some embodiments that may be used by manufacturer representative administrators (or supervisor) to register with the site. FIG. 11A shows an exemplary interface for allowing a manufacturer to enter their information during registration. FIG. 11B shows an exemplary interface for allowing a manufacturer representative administrator to provide information about the, number representatives that may be added to their manufacturer account and specify the billing procedure (e.g., have the manufacturer pay for all reps or have each rep pay individually billed fees). FIG. 11C shows an exemplary interface for allowing a manufacturer representative administrator to submit further payment information. FIG. 11D shows an exemplary interface for allowing a manufacturer representative administrator to invite representatives to be a registered representative for that manufacturer. As described in connection with FIG. 9, this information may be stored and used to automatically verify new representative credentials during registration. In some embodiments, the manufacturer administrative representative may have the option to upload a spreadsheet or similar document that allows the administrator specify numerous authorized representatives quickly and efficiently. FIG. 11E shows an exemplary interface for allowing the manufacturer representative to receive the invitation from the administrator and to activate their account with the particular manufacturer.

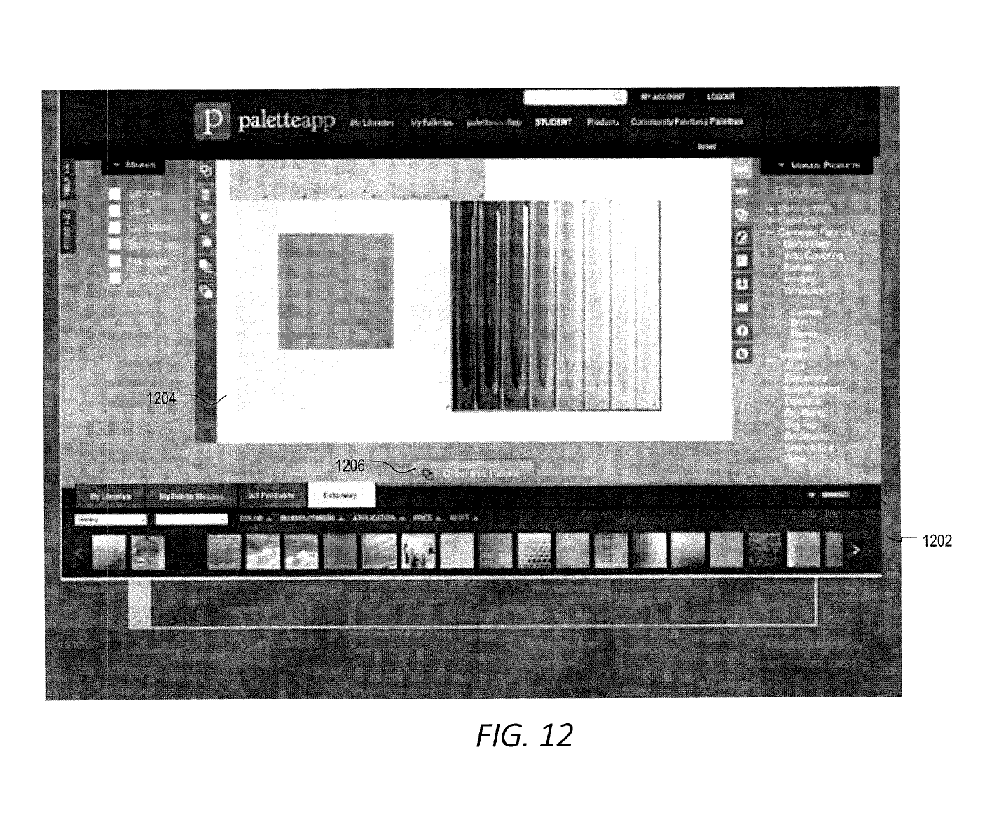

FIG. 12 shows exemplary screenshots of webpages or interfaces of an exemplary electronic sample palette website according to some embodiments for allowing registered representatives to perform additional functions by navigating to a sample box or palette interface. In this example, only some features are illustrated and additional features may be provided as described in connection with FIGS. 2-9. This displayed interface, however, allows representatives to select filters, such as a product type, name, and feature. When a product name is selected the available colorway samples will appear under the colorway portion 1202 of the interface. The samples may be dragged into the sample box or palette 1204 for ordering. To order samples, cut sheets, project binders, etc., the representative may simply click on the Order Sample 1206 and input the project information as described further in FIG. 9. All inputted data will be automatically downloaded into the CRM and databases and may be utilized to allow representatives and representative administrators to retrieve data and generate analytics reports. As described in connection FIG. 9, data for all sample orders and activity for representatives is stored to the CRM and searchable by a number of criteria.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for generating design sample palettes over a network, comprising:
a database storing design products related to a plurality of categories of commercial products from a plurality of manufacturers;
interface circuitry for displaying the plurality of categories of commercial products and filtering criteria that may be selected by a user;
a sample palette server in operative communication with the database and the interface circuitry that receives a user selection of one or more filtering criteria specifying one or more requested design features and generates a subset of the design products sharing at least one design feature in common with the requested design features;
filtering circuitry that filters the displayed plurality of categories of commercial products to include only design products from the subset of design products and causes the interface circuitry to display a second set of filtering criteria for the displayed plurality of categories of commercial products; and
sample palette generating circuitry that receives a user selection of a plurality of commercial products from the displayed subset of design products and generates a sample palette including graphical images of the plurality of commercial products.

2. The system of claim 1, wherein the interface circuitry further receives selection of a class of material use for a requested design product.

3. The system of claim 2, wherein the interface circuitry dynamically displays filtering criteria customized to the selected class of material use.

4. The system of claim 3, wherein the filtering criteria include criteria related to construction standards for performance and safety requirements of the submitted class of materials.

5. The system of claim 1, wherein the filtering criteria are provided in a hierarchical format of three or more levels of product categories and product features, and wherein each subsequent level of filtering criteria is dynamically displayed in response to selecting a feature at a preceding filtering level.

6. The system of claim 5, wherein a first level of filtering criteria is displayed in response to receiving a selection of a class of material use for a requested design product and includes product types and categories in the class of material use.

7. The system of claim 6, wherein a second level of filtering criteria is displayed in response to receiving a selection of a product type or category and includes product-specific construction specifications or construction standards for the selected product type or category.

8. The system of claim 7, wherein a third level of filtering criteria is displayed in response to receiving the selection of a product type or category and includes functional filters based on functional features of design products sharing the selected product type or category, wherein the functional features include product configuration or operational features of the design products sharing the selected product type or category.

9. The system of claim 8, wherein a fourth level of filtering criteria is displayed in response to receiving the selection of a product type or category and includes aesthetic filters based on aesthetic features of design products sharing the selected product type or category, wherein the aesthetic features include product dimensions or a number of each of the functional features selected at the third level of filtering criteria.

10. The system of claim 1, further comprising authorization circuitry that verifies a user is a manufacturer representative and associates the user's activity with a manufacturer account.

11. The system of claim 10, further comprising:
analytics circuitry communicatively coupled with the database that accesses the design product data and generates analytics reports showing performance of all manufacturer representatives associated with a manufacturer account.

12. The system of claim 10, wherein the user account of the authorized manufacturer representative is authorized to order product samples from manufacture for each product in the sample palette

13. A non-transitory computer readable medium having stored therein data representing instructions executable by a programmed processor for generating design sample palettes over a network, the storage medium comprising instructions operative for:
displaying filtering criteria on a user interface and receiving a first selection of one or more filtering criteria;
querying a database storing design product data using the selected filtering criteria;
generating a set of design products sharing at least design feature in common with the requested design features and displaying the set of design products on the user interface;
generating a second set of filtering criteria in response to the first selection of one or more filtering criteria and displaying the second set of filtering criteria on the user interface;
receiving a second selection of one or more filtering criteria from the second set of filtering criteria;
filtering the displayed set of design products subset of design products based on second selection and displaying only design products meeting the second selected filtering criteria; and
generating a design sample palette including graphical images of at least one design product from the filtered displayed set of design products.

14. The storage medium of claim 12, further comprising:
generating a third set of filtering criteria in response to the second selection of one or more filtering criteria and displaying the third set of filtering criteria on the user interface;
receiving a third selection of one or more filtering criteria from the third set of filtering criteria;
filtering the displayed set of design products subset of design products based on third selection and displaying only design products meeting the third selected filtering criteria; and
receiving a selection of at least one displayed design product meeting the third selected filtering criteria and adding a graphical image of the selected displayed design product to the design sample palette.

15. A system for generating design sample palettes over a network, comprising a database storing a plurality of design products related to a plurality of categories of commercial products from a plurality of manufacturers;
interface circuitry for displaying a subset of the plurality of design products on a user interface and receiving selection of one or more filtering criteria specifying one or more requested design features;
a sample palette server in operative communication with the database and the interface circuitry that receives the selected filtering criteria and filters the displayed design products to include only those meeting the selected filtering criteria;
sample palette generating circuitry that generates a sample palette including graphical images of design products from the filtered design products for display on the user interface,
wherein the sample palette allows a user to add and delete additional design products from the sample palette from the filtered design products; and
account authorization circuitry that verifies a user account is an authorized manufacturer representative and associates the user account's activity and the generated sample palette with a manufacturer account.

16. The system of claim 14, wherein the user account of the authorized manufacturer representative is authorized to order product samples from manufacture for each product in the sample palette.

17. The system of claim 14, wherein the manufacturer account is billed for account activity of all authorized manufacturer representatives associated with the manufacturer account.

18. The system of claim 14, wherein the user account is associated with two or more manufacturer accounts.

19. The system of claim 14, wherein the account authorization circuitry further verifies that the user account is a supervisor account for the manufacturer account and enables access to activity data for all authorized manufacturer representatives associated with the manufacturer account.

20. The system of claim 18, further comprising:
analytics circuitry communicatively coupled with the database that allows the supervisor account to generate analytics reports showing past orders of all authorized manufacturer representatives associated with the manufacturer account.
